(19) United States
(12) Patent Application Publication
(10) Pub. No.: US 2017/0192612 A1
(43) Pub. Date: Jul. 6, 2017

(54) IDENTIFYING BODY FOR TOUCH-SENSOR SYSTEM AND TOUCH-SENSOR SYSTEM

(71) Applicant: SHARP KABUSHIKI KAISHA, Sakai City, Osaka (JP)

(72) Inventor: Hideaki SHINYA, Osaka (JP)

(73) Assignee: SHARP KABUSHIKI KAISHA, Sakai City, Osaka (JP)

(21) Appl. No.: 15/313,324

(22) PCT Filed: Apr. 23, 2015
(86) PCT No.: PCT/JP2015/002206

§ 371 Date: Nov. 22, 2016

(30) Foreign Application Priority Data
May 28, 2014 (JP) 2014-110501

(51) Int. Cl. G06F 3/041; G06F 3/044

(52) U.S. Cl. CPC G06F 3/0418; G06F 3/044; G06F 2203/04104; G06F 21/32

(57) ABSTRACT

A shape of a code identifying body as seen from a touch panel surface is more accurately detected not by correcting a ghost on a controller side of a touch-sensor system or distinguishing the ghost from a real touch by a sensor unit but by rectifying the ghost on the code identifying body side and increasing a detection signal.

An identifying body 1 for a touch-sensor system includes a conductive pattern unit 2 in which a conductive pattern in a prescribed shape is arranged to be opposed to a screen of a touch panel of a touch-sensor system 4 and a virtual grounding circuit unit 3 that has an equivalent function to a ground circuit for the conductive pattern, is installed on a touch panel surface of the touch-sensor system 4 that enables a position input operation of an indicating body, and is used for user authentication and so forth.

### TECHNICAL FIELD

The present invention relates to an identifying body for a touch-sensor system for performing user authentication and a touch-sensor system in which the identifying body is used to perform identification and a touch or multi-touch input operation is performed.

### BACKGROUND ART

In recent years, systems have been constructed which use networks to take out information accumulated in databases in various places. For example, in PTL 1, in a case where a printing device makes a print request for print data that are temporarily accumulated on a server and the print data are thereby output from the printing device, identification information is used to perform user authentication for an electronic apparatus.

Meanwhile, touch-sensor techniques have been rapidly developed as an input device of a computing system accompanying the spread of smart phones and tablet PCs. Touch panel techniques in the early days identify an input position by one touch. However, a main current in the present days is a touch panel that is capable of detecting plural simultaneous touch inputs (multi-touch inputs). As a method of detecting plural simultaneous touch inputs, there is a capacitive scheme in which the changes in the charges of sensors arranged in a matrix manner are read.

A problem that may occur in the capacitive scheme is that a signal may be detected in a position other than the position which the user intends to touch on a screen. This has been known as a ghost touch or a ghost point (here, simply referred to as ghost). The ghost that occurs in a touch-sensor system that detects multi-touch inputs is caused by an interference by a sensor via an indicating body in a case where a grounding condition of the indicating body such as a finger of a person is insufficient. PTL 2 discloses a technique of correcting the ghost on a controller side of the touch-sensor system. PTL 3 discloses a technique of distinguishing the ghost from a real touch by a sensor unit of the touch-sensor system.

### CITATION LIST

### Patent Literature

PTL 1: Japanese Unexamined Patent Application Publication No. 2006-99714

PTL 2: Japanese Unexamined Patent Application Publication (Translation of PCT Application) No. 2012-502397

PTL 3: Japanese Unexamined Patent Application Publication No. 2011-138469

### SUMMARY OF INVENTION

### Technical Problem

For the user authentication for the electronic apparatus in PTL 1, it is necessary that a special input device such as an IC card reader is provided. However, in a case where the touch panels used for operation panels of a large number of electronic apparatuses are used as sensors and reading for the user authentication may thereby be performed directly, a separate input device does not have to be provided. Accordingly, the configuration may be simplified, and significant cost reduction may be expected.

However, in a case where a conductor is placed on the touch panel, a ghost signal occurs due to an interference between drive lines and sense lines of the touch panel, a detected capacitance signal becomes unstable, and position detection becomes unstable. In order to use the touch panel as the sensor to perform reading for the user authentication, a conductive pattern in a complicated shape has to be recognized. Thus, a conductive pattern of the point in which the above interference is caused corresponds to a wide region compared to a touch region with a limited small area by the finger of a person, and a more complicated ghost signal occurs. This results in a problem that the position detection becomes more difficult.

Those techniques disclosed in PTL 2 and PTL 3 take into account a touch by the finger of a person onto a touch panel surface but do not take into account a strong interference as in a floating conductive material or reading of a conductive pattern in a complicated shape. In a case where the disclosed techniques are used, problems occur that the correction calculation amount is very huge, the touch-sensor system is complicated and intricate, the number of position detectable points is limited, and so forth.

The present invention has been made to solve the above problems in related art, and an objective thereof is to provide an identifying body for a touch-sensor system that may more accurately detect a shape of the identifying body as seen from a touch panel surface not by correcting a ghost on a controller side of the touch-sensor system or distinguishing the ghost from a real touch by a sensor unit but by rectifying the ghost on the identifying body side and a touch-sensor system that uses the identifying body.

### Solution to Problem

An identifying body for a touch-sensor system of the present invention includes: a conductive pattern unit in which a conductive pattern is formed in a shape to be recognized by the touch-sensor system by being brought into contact with or into close vicinity to a touch panel surface of the touch-sensor system; and a virtual grounding circuit unit that is connected with the conductive pattern unit and has an energy loss unit which consumes energy with respect to a frequency of a drive signal which is used by the touch-sensor system. Accordingly, the above object is achieved.

Further, in the identifying body for a touch-sensor system of the present invention, the energy loss unit may include a series resonance circuit.

Further, in the identifying body for a touch-sensor system of the present invention, an antenna circuit is preferably used as the virtual grounding circuit unit.

Further, in the identifying body for a touch-sensor system of the present invention, the energy loss unit may be configured to resonate at a frequency lower than the drive frequency.

Further, in the identifying body for a touch-sensor system of the present invention, as the virtual grounding circuit unit, a coil circuit or a coil circuit that includes an eddy-current loss unit (a conductor around a coil) is preferably used.

Further, in the identifying body for a touch-sensor system of the present invention, the conductive pattern is preferably a portion of or the whole of the virtual grounding circuit unit.

Further, in the identifying body for a touch-sensor system of the present invention, the conductive pattern is preferably a portion of or the whole of the virtual grounding circuit unit, and the conductive pattern is preferably formed of a coil.

The identifying body for a touch-sensor system of the present invention is virtually grounded by contacting with or approaching the touch panel surface of the touch-sensor system that enables a position input operation of the indicating body and enables the touch-sensor system to read the indicating body which is not grounded. Accordingly, the above object is achieved.

Further, the identifying body for a touch-sensor system of the present invention preferably has a conductive pattern unit in which a conductive pattern in a prescribed shape as a shape of the indicating body is arranged to be opposed to the touch panel surface and a virtual grounding circuit unit that is connected with the conductive pattern and has an equivalent function to a ground circuit for the conductive pattern.

Further, in the identifying body for a touch-sensor system of the present invention, the conductive pattern unit in which the conductive pattern in a prescribed shape as the shape of the indicating body is arranged to be opposed to the touch panel surface is preferably provided, and the conductive pattern is preferably the virtual grounding circuit unit that has an equivalent function to the ground circuit.

Further, the virtual grounding circuit unit in the identifying body for a touch-sensor system of the present invention is preferably configured with at least one of a coil circuit and an antenna circuit.

A touch-sensor system of the present invention enables reading and identification of the shape of the conductive pattern of the identifying body for the touch-sensor system by installing the identifying body for a touch-sensor system of the present invention on the touch panel surface that enables a position input operation of the indicating body. Accordingly, the above object is achieved.

Effects of the present invention will be described below based the above configurations.

In the present invention, there are provided the conductive pattern unit in which the conductive pattern is formed in a shape to be recognized by the touch-sensor system by being brought into contact with or into close vicinity to a touch panel surface of the touch-sensor system and the virtual grounding circuit unit that is connected with the conductive pattern unit and has the energy loss unit which consumes energy with respect to the frequency of a drive signal which is used by the touch-sensor system.

Accordingly, the energy loss unit consumes energy with respect to the frequency of the drive signal used in the touch-sensor system, and even in a case of the indicating body that is not grounded, the indicating body is virtually grounded and thereby has an equivalent function to the ground circuit. Thus, differently from related art in which the ghost is corrected on the controller side of the touch-sensor system or the ghost is distinguished from a real touch by the sensor unit, the ghost is rectified on the identifying body side, and the shape of the identifying body as seen from the touch panel surface may thereby be detected more accurately.

### Advantageous Effects of Invention

As described above, in the present invention, the energy loss unit consumes energy with respect to the frequency of the drive signal used in the touch-sensor system, and even in a case of the indicating body that is not grounded, the indicating body is virtually grounded and thereby has an equivalent function to the ground circuit. Thus, differently from related art in which the ghost is corrected on the controller side of the touch-sensor system or the ghost is distinguished from a real touch by the sensor unit, the ghost is rectified on the identifying body side, and the shape of the identifying body as seen from the touch panel surface may thereby be detected more accurately. In addition, a signal to be detected may be increased.

### BRIEF DESCRIPTION OF DRAWINGS

FIG. 1 is a block diagram that illustrates a configuration example of an identifying body for a touch-sensor system in a first embodiment of the present invention.

FIG. 2 is a plan view that illustrates examples of a conductive pattern in a conductive pattern unit in FIG. 1.

FIG. 3 is a schematic diagram that illustrates examples of security authentication by placing the identifying body for a touch-sensor system on which a virtual grounding circuit is mounted on a touch panel of the touch-sensor system in FIG. 1.

FIG. 4 is a block diagram that illustrates a configuration example of a virtual grounding circuit unit in FIG. 1.

FIG. 5(a) is a schematic diagram that schematically illustrates a partial planar configuration example of the touch panel of the touch-sensor system in FIG. 1, and FIG. 5(b) is a signal waveform diagram that is obtained from the touch panel.

FIG. 6(a) is an equivalent circuit diagram of a capacitive touch-sensor system of a self-capacitance type, and FIG. 6(b) is an equivalent circuit diagram for explaining a capacitance detection mechanism of the capacitive touch-sensor system.

FIG. 7(a) is an equivalent circuit diagram of a capacitive touch-sensor system of a mutual capacitance type, and FIG. 7(b) is an equivalent circuit diagram for explaining the capacitance detection mechanism of the capacitive touch-sensor system.

FIG. 8 is equivalent circuit diagrams of a state where a floating conductor is placed on one intersection on the touch panel of the capacitive touch-sensor system of the mutual capacitance type, FIG. 8(a) is an equivalent circuit diagram that illustrates a case where the drive signal applied to the drive line is a low voltage, and FIG. 8(b) is an equivalent circuit diagram that illustrates a case where the drive signal applied to the drive line is a high voltage.

FIG. 9 is a schematic diagram that illustrates a planar state where a prescribed floating conductor is placed on one region of the touch panel of the touch-sensor system in FIG. 1.

FIG. 10(a) is a schematic diagram that illustrates a planar state where a prescribed floating conductor is placed on one region of the touch panel of the touch-sensor system in FIG. 1, and FIG. 10(b) is an equivalent circuit diagram of a case where a prescribed floating conductor is placed on the capacitive touch-sensor system of the mutual capacitance type.

FIG. 11 is an equivalent circuit diagram of a state where a contacting object is placed on the capacitive touch-sensor system of the mutual capacitance type.

FIG. 12 is an equivalent circuit diagram of a case where the virtual grounding circuit is made a series resonance circuit by the contacting object in FIG. 11.

FIG. 13(a) is an equivalent circuit diagram of a case where contact capacitances and the series resonance circuit are caused to resonate by the contacting object in FIG. 11, and FIG. 13(b) is a diagram that represents the equivalent circuit in FIG. 13(a) by a power factor.

FIG. 14(a) is an equivalent circuit diagram in which RL series circuit components of the contacting object are connected with both sides of a parasitic capacitance in a case where an operation is performed at a higher drive frequency than a resonance frequency, and FIG. 14(b) is a diagram that represents the equivalent circuit in FIG. 14(a) by the power factor.

FIGS. 15(a) and 15(b) are current waveform diagrams for explaining a position detection mechanism by signal inversion in a case where the virtual grounding circuit is designed with an active element (an element that has a power source).

FIG. 16 FIGS. 16(a) and 16(b) are current waveform diagrams for explaining a position detection mechanism by phase delay in a case where the virtual grounding circuit is designed with the active element (the element that has a power source).

FIG. 17 is a plan view that illustrates a detection example of the conductive pattern in a case where the conductive pattern in a circular shape with a diameter of 20 mm is alone placed on the touch panel of the touch-sensor system in FIG. 1.

FIG. 18 is a plan view that illustrates a detection example of the conductive pattern in a case where the conductive pattern in the circular shape with a diameter of 20 mm and the virtual grounding circuit are placed on the touch panel of the touch-sensor system in FIG. 1.

FIG. 19 is capacitance signal distribution diagrams of the conductive pattern in a circular shape, FIG. 19(a) is a capacitance signal distribution diagram in a floating state, FIG. 19(b) is a capacitance signal distribution diagram in a ground state, and FIG. 19(c) is a capacitance signal distribution diagram of virtual grounding by a monopole antenna.

FIG. 20 is a block diagram that illustrates a configuration example of an identifying body for a touch-sensor system in a second embodiment of the present invention.

FIG. 21 is a perspective view that schematically illustrates a specific example of the identifying body for a touch-sensor system in the second embodiment of the present invention.

FIG. 22 is a perspective view that illustrates another specific example of the identifying body for a touch-sensor system in the second embodiment of the present invention.

FIG. 23 is a block diagram that illustrates another configuration example of the identifying body for a touch-sensor system in the second embodiment of the present invention.

FIG. 24 is a block diagram that illustrates a configuration example of an identifying body for a touch-sensor system in a third embodiment of the present invention.

FIGS. 25(a) to 25(c) are respective plan views that schematically illustrate external shape examples of conductive patterns formed of coils.

FIG. 26(a) is a schematic diagram that illustrates a planar state where the identifying body for a touch-sensor system with a prescribed conductive pattern is placed on one region of the touch panel of the touch-sensor system in FIG. 1, and FIG. 26(b) is a block diagram that illustrates a configuration example of the identifying body for a touch-sensor system in FIG. 26(a).

FIGS. 27(a) and 27(b) are plan views that schematically illustrate the conductive pattern.

FIG. 28 is a block diagram that illustrates an overall configuration example of a touch-sensor system in a fourth embodiment of the present invention.

FIG. 29 is a block diagram that illustrates a configuration example in a controller of the touch-sensor system in FIG. 28.

### REFERENCE SIGNS LIST

1, 1A to 1C identifying body for touch-sensor system
2, 2C conductive pattern unit
21, 23 conductive pattern
22 bottom surface
3, 3A to 3C virtual grounding circuit unit
31 conductive pattern connection unit
32, 32A to 320 ground compensating circuit unit
321, 321A, 323 coil
321B region
322 conductor
324a, 324b contact capacitance
325 antenna
326 loss resistance component
4, 4A, 45, 4D touch-sensor system
41 touch panel
42 reference current signal waveform in case where no indicating object is placed
43 current signal waveform in case where indicating object is placed
44 to 46 capacitance signal region (detection region)
101, 102, 103, 104 drive line
111, 112, 113, 114 sense line
C1 to C3 contact capacitance
C, Cs parasitic capacitance
I, I1, I2 current
P1 to P4 intersection
E1 contacting object
5 indicating object (grounded indicating object such as finger)
6, 61, 62 floating conductor
7 display device
81 connection unit
82 control board
83 controller unit
830 indicating body position detection unit
831 amplification unit
832 signal acquisition unit
833 A/D conversion unit
834 decoding process unit
835 detection reference configuration unit
836 position information generation unit
837 drive line driving unit
84 connection cable
9 host terminal

### DESCRIPTION OF EMBODIMENTS

First to third embodiments of an identifying body for a touch-sensor system of the present invention and a fourth embodiment of a touch-sensor system that uses the identifying body for a touch-sensor system will hereinafter be described in detail with reference to drawings. It should be noted that sizes and so forth of configuration members in the drawings are not limited to the illustrated configurations in view of preparation of drawings.

### First Embodiment

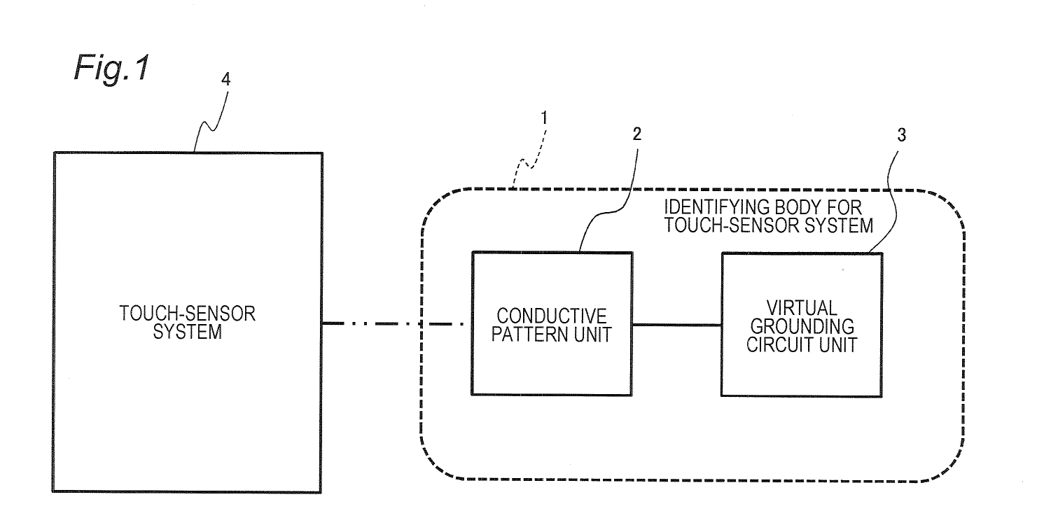

FIG. 1 is a block diagram that illustrates a configuration example of an identifying body for a touch-sensor system in the first embodiment of the present invention.

In FIG. 1, an identifying body 1 for a touch-sensor system of the first embodiment includes a conductive pattern unit 2 in which a conductive pattern in a prescribed shape is arranged to be opposed to a screen of a touch panel of a touch-sensor system 4 and a virtual grounding circuit unit 3 that has an equivalent function to a ground circuit for the conductive pattern, is installed on a touch panel surface of the touch-sensor system 4 that enables a position input operation of an indicating body, and is used for user authentication and so forth. In brief, the identifying body 1 for a touch-sensor system contacts with or approaches the touch panel surface of the touch-sensor system 4 that enables the position input operation of the indicating body such as a finger, and a conductive pattern 21 in a prescribed shape, which is not grounded and will be described later, is thereby caused to become a virtual ground state, thereby enabling reading by the touch-sensor system 4.

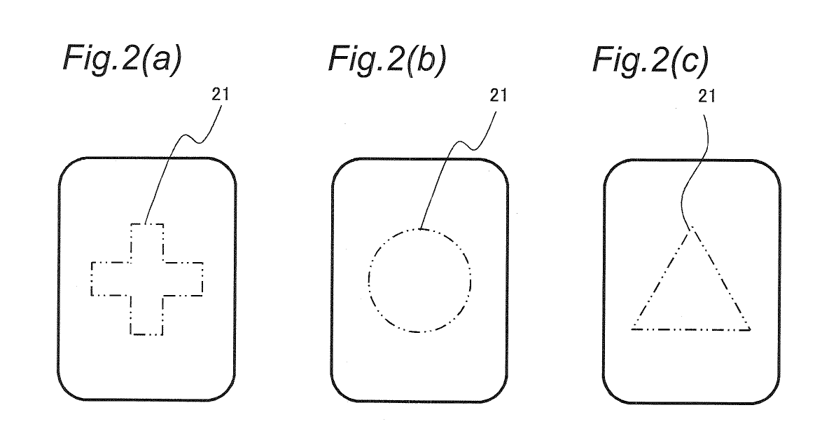

The conductive pattern unit 2 is formed of a conductive material in various shapes such as cross (FIG. 2(a)), circle (FIG. 2(b)), triangle (FIG. 2(c)), and rectangle which is not illustrated (square, oblong rectangle, rhombus, and trapezoid) as shapes in a plan view as seen from the touch panel surface as the conductive pattern so that the touch-sensor system 4 is caused to respond (detect the shape). The shape of the conductive pattern 21 indicates code information such as ID information for the user authentication. Those various shapes may be, in addition to the above-described figures, a shape as a combination of plural figures (for example, a combination of a circle and a triangle corresponds to a prescribed character, a combination of a circle and a rectangle corresponds to another character, and so forth) or a character string that includes a number string and a symbol string. It is matter of course that the character string may not include a number string or a symbol string. Because the identifying body 1 for a touch-sensor system that is used here is placed on the touch panel surface, in order to improve the viewability of a display screen under that, a base material of the identifying body 1 for a touch-sensor system is preferably made transparent, and a mesh pattern of a conductive material and a transparent electrode such as ITO are preferably used. However, a solid electrode such as aluminum may be used for the conductive pattern. As described above, in view of security, the shape of the conductive pattern of the conductive material is preferably processed so that the shape may not be visually recognized from the outside by coating a surface of the conductive pattern with an opaque resin membrane or the like.

In a case where drive signals that are applied to plural drive lines of the touch-sensor system 4 are alternate current signals and energy is consumed by a frequency change of the alternate current signal, the virtual grounding circuit unit 3 works the same as a case where a current flows and a charge is consumed and thus is configured so as to have an equivalent function to the ground circuit for the conductive pattern.

### Examples of Security Authentication

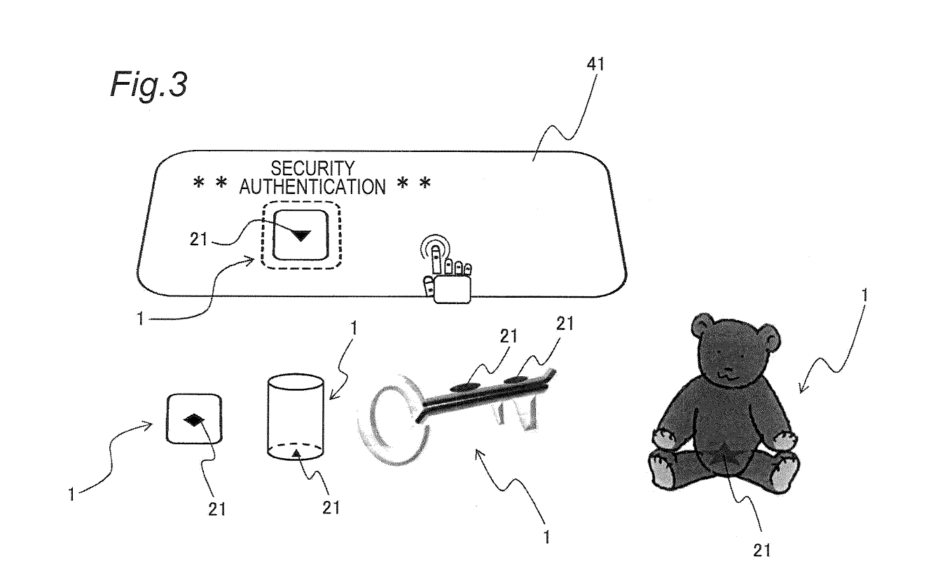

FIG. 3 is a schematic diagram that illustrates examples of security authentication by placing the identifying body 1 for a touch-sensor system on which the virtual grounding circuit 3 is mounted on a touch panel 41 of the touch-sensor system 4 in FIG. 1.

FIG. 3 illustrates a state where the identifying body 1 for a touch-sensor system is installed on the touch panel 41 of the touch-sensor system 4 that includes an authentication system, a prescribed region on a sensor screen of the touch panel 41 is touched by the indicating body such as a finger, and a function that corresponds to the touch region is operated to operate an information apparatus.

The information apparatus reads in the conductive pattern 21 of the identifying body 1 for a touch-sensor system on the touch panel 41, determines the user of the information apparatus, and displays an appropriate operation screen on the screen of the touch panel 41. The user may use the information apparatus by operating the operation screen by the touch panel 41.

As for the conductive pattern 21 of the identifying body 1 for a touch-sensor system, the conductive pattern 21 side is preferably placed on the sensor screen of the touch panel 41 so that the shape as seen from the sensor screen of the touch panel 41 may be read. The conductive pattern 21 may be arranged on a flat plane or a bottom surface of a solid body, may be arranged on a bottom surface of a column (or a square column) such as a seal, may be arranged on a key-shaped member, and may be arranged on bottoms of a stuffed toy, a doll, and so forth. Further, the column or the doll itself may be a conductor, and a bottom shape thereof may be read. The ID information may be indicated by the difference in the shape of the conductive pattern 21, and identification may be performed in accordance with the change in a signal that is read from a sensor of the touch panel surface.

### Configuration Example of Virtual Grounding Circuit Unit 3

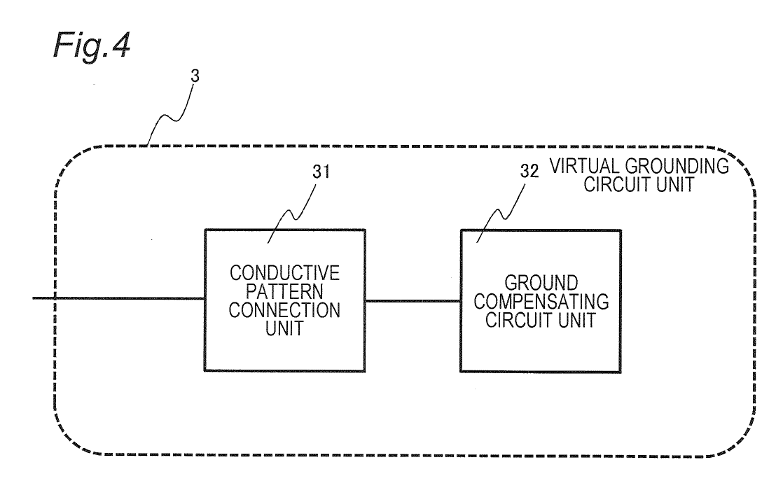

FIG. 4 is a block diagram that illustrates a configuration example of the virtual grounding circuit unit 3 in FIG. 1.

In FIG. 4, the virtual grounding circuit unit 3 has a conductive pattern connection unit 31 and a ground compensating circuit unit 32 that is connected with the conductive pattern unit 2 via the conductive pattern connection unit 31. A function of the ground compensating circuit unit 32 is realized such that the conductive pattern unit 2 works in a similar manner to a grounded state.

The conductive pattern connection unit 31 is a portion that connects the conductive pattern unit 2 with the ground compensating circuit unit 32 and is preferably connected at a low impedance so as not to disturb the design of the ground compensating circuit unit 32. Further, in a case where the ground compensating circuit unit 32 is formed of a conductive material, the conductive pattern connection unit 31 may have a role to electrically shield the ground compensating circuit unit 32 so that the ground compensating circuit unit 32 does not respond to the touch-sensor system 4.

The ground compensating circuit unit 32 is a circuit for a purpose of compensating the change in the charge with respect to the frequency of the drive signal that is used in the touch-sensor system 4. The ground compensating circuit unit 32 is a structure that produces energy loss with respect to the frequency of the drive signal, or the structure may be realized by an antenna that operates at the frequency of the drive signal.

The conductive pattern connection unit 31 and the ground compensating circuit unit 32 as configurations of the virtual grounding circuit unit 3 may be integrally configured to have both of the functions.

### Examples of Touch Panel and Output Signal Waveform Thereof

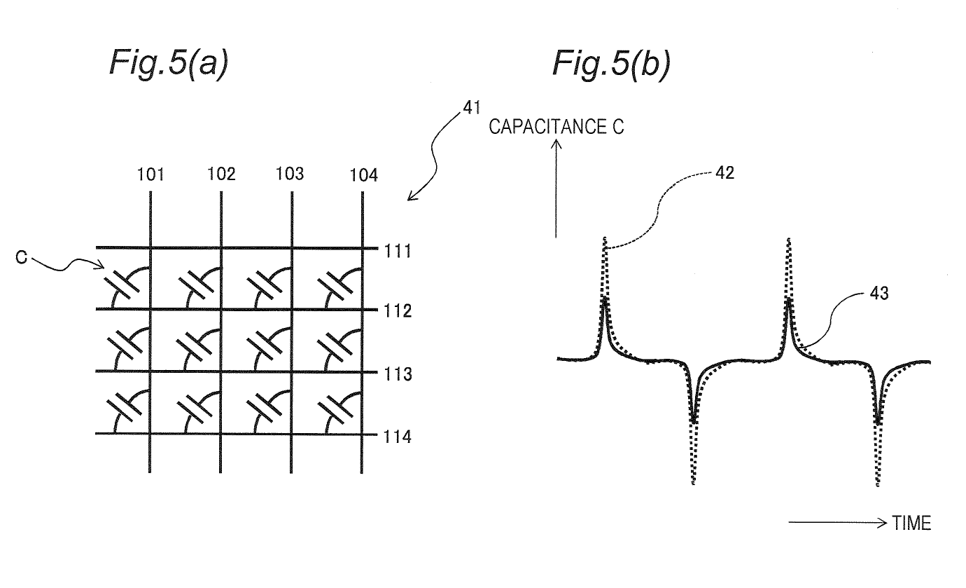

FIG. 5(a) is a schematic diagram that schematically illustrates a partial planar configuration example of the touch panel 41 of the touch-sensor system 4 in FIG. 1, and FIG. 5(b) is a signal waveform diagram that is obtained from the touch panel 41.

As illustrated in FIG. 5(a), as for the capacitive touch-sensor system 4, in the touch panel 41, alternate current signals referred to as drive signal are applied to plural drive lines 101, 102, 103, and 104 that are arranged in parallel in the longitudinal direction, the changes in current signal waveforms of plural parallel sense lines 111, 112, 113, and 114 that orthogonally and three-dimensionally intersect the respective the drive lines 101, 102, 103, and 104 are detected, and the change in a capacitance C in each place is thereby detected.

As illustrated in FIG. 5(b), a reference numeral 42 represents a reference current signal waveform in a state where no indicating object is placed on the sensor surface of the touch panel 41. In a case where an indicating object is placed on the sensor surface of the touch panel 41, the current signal waveform increases or decreases as a current signal waveform 43 with respect to the current signal waveform 42. The touch-sensor system 4 reads the increase and decrease in the current signal waveform. This change amount is provided as the change in the capacitance C. In a case where the indicating object such as a finger is placed on the sensor surface of the touch panel 41, the capacitance C of the intersection portion between the drive line and the sense line, which corresponds to the placement, increases or decreases. The drive lines 101, 102, 103, and 104 and the sense lines 111, 112, 113, and 114 may be reversed, and the lines to which the drive signal is applied and the lines for sensing may be alternated.

### (Capacitance Detection Mechanism by Finger Touch)

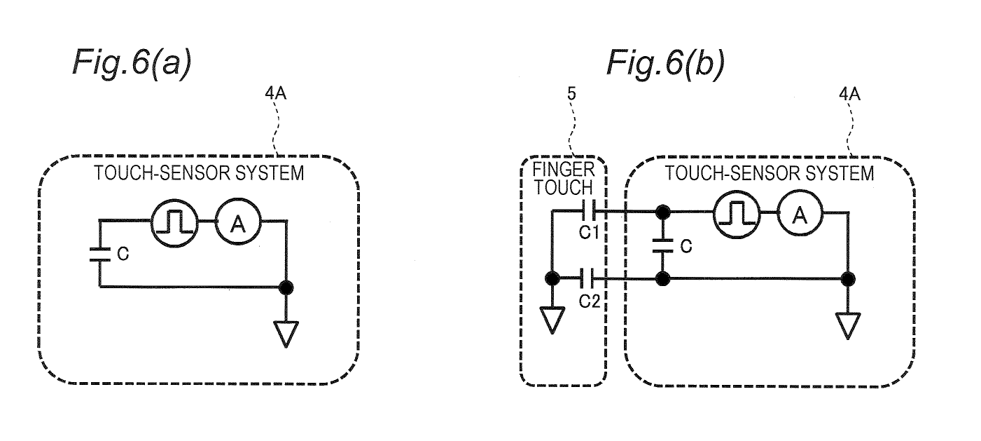

FIG. 6(a) is an equivalent circuit diagram of a capacitive touch-sensor system 4A of a self-capacitance type, and FIG. 6(b) is an equivalent circuit diagram for explaining a capacitance detection mechanism of the capacitive touch-sensor system 4A.

As illustrated in FIG. 6(a), the capacitive touch-sensor system 4A of the self-capacitance type applies a drive voltage and detects the current of the same line and thereby reads a touch position based on whether the detected current changes (the capacitance C changes). In this case, it may be assumed that when the finger of a person touches the sensor surface of the touch panel, grounding is made to both ends of the capacitance C in parallel via capacitances C1 and C2.

When a state where no indicating object 5 is placed on the sensor surface of the touch panel of the capacitive touch-sensor system 4A of the self-capacitance type changes into a state where the indicating object 5 such as a finger is placed on the sensor surface as illustrated in FIG. 6(b), the impedance for an ammeter A decreases compared to the state where no indicating object 5 is placed, and the current thus increases compared to the state where no indicating object 5 is placed. The capacitance increases by the increase in the current. Note that a direct current resistance and an inductance component are not indicated. As described above, a determination is made that the finger touch is made in the position where the capacitance C increases.

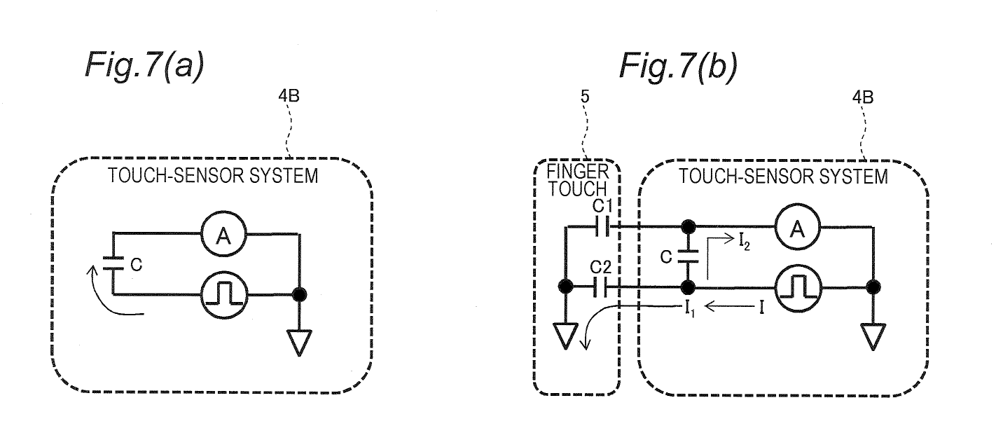

FIG. 7(a) is an equivalent circuit diagram of a capacitive touch-sensor system 4B of a mutual capacitance type, and FIG. 7(b) is an equivalent circuit diagram for explaining the capacitance detection mechanism of the capacitive touch-sensor system 4B.

As illustrated in FIG. 7(a), the capacitive touch-sensor system 45 of the mutual capacitance type applies the drive voltage to the drive line on a lower side and detects a current I by the sense line above the drive line and thereby reads the touch position based on whether the detected current I changes (the capacitance C changes). In this case, it may be assumed that when the finger of a person touches the sensor surface of the touch panel, grounding is made to both ends of the capacitance C in parallel via the capacitances C1 and C2.

When a state where nothing is placed on the sensor surface of the touch panel of the capacitive touch-sensor system 45 of the mutual capacitance type changes into a state where the indicating object 5 such as a finger is placed on the sensor surface as illustrated in FIG. 7(b), the capacitive touch-sensor system 4B is grounded to both of the ends of the capacitance C in parallel via the capacitances C1 and C2. Thus, a current I2 that flows through the ammeter A becomes lower than the current I because a current I1 is subtracted from the current I, compared to the state where the indicating object 5 is not placed. The capacitance C also decreases by the decrease in the current. As described above, a determination is made that the finger touch is made in the position where a capacitance C decreases.

### (Capacitance Detection Mechanism by Floating Conductor Touch)

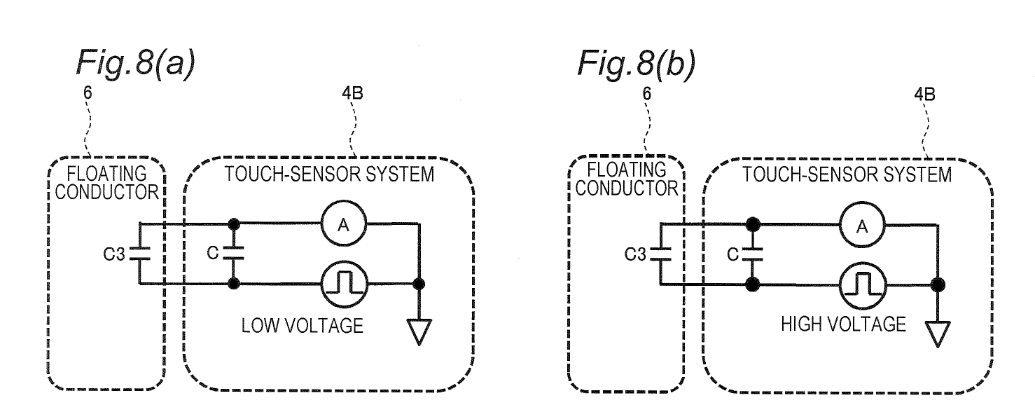

FIG. 8 is equivalent circuit diagrams of a state where a floating conductor is placed on one intersection on the touch panel of the capacitive touch-sensor system 4B of the mutual capacitance type, FIG. 8(a) is an equivalent circuit diagram that illustrates a case where the drive signal applied to the drive line is a low voltage, and FIG. 8(b) is an equivalent circuit diagram that illustrates a case where the drive signal applied to the drive line is a high voltage.

As illustrated in FIG. 8(a) and FIG. 8(b), in a case where a floating conductor 6 is placed on the touch panel of the capacitive touch-sensor system 4B of the mutual capacitance type, an equivalent circuit to a state where a stray capacitance C3 is in parallel inserted in the drive lines driven by the touch-sensor system 4B and the sense lines is provided. In this state, when an alternate current drive signal to the drive line is inverted from the low voltage to the high voltage or from the high voltage to the low voltage, the current flows through a parallel circuit of the capacitance C and the stray capacitance C3, the charge of the charged stray capacitance C3 flows from the floating conductor 6 side to the capacitive touch-sensor system 4B side, and further the current that flows through the ammeter A via the sense line increases. Accordingly, a determination is made that the capacitance increases. It may be considered that the same applies to the self-capacitance type.

In brief, in a case where the finger touches one point region on the touch panel, the current flows to the finger side, and the sensed current I decreases. The capacitance C also decreases by the decrease in the current. As described above, a determination is made that the finger touch is made in the position where the capacitance C decreases. On the other hand, in a case of the floating conductor 6, the current flows from the floating conductor 6 side, and the sensed current I increases. Accordingly, a determination is made that the capacitance increases. As described above, the finger causes the capacitance C to change in the decreasing direction, and the floating conductor 6 causes the capacitance C to change in the increasing direction.

### (Occurrence of Ghost)

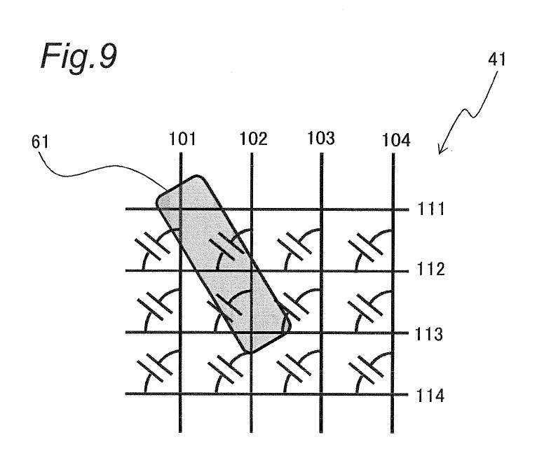

FIG. 9 is a schematic diagram that illustrates a planar state where a prescribed floating conductor 61 is placed on one region of the touch panel of the touch-sensor system 4 in FIG. 1.

In FIG. 9, the floating conductor 61 in an oblong rectangle in a plan view is arranged on the touch panel 41 across plural intersections of the intersection between the drive line 101 and the sense line 111, the intersection between the drive line 102 and the sense line 112, and the intersection between the drive line 102 and the sense line 113. In this case, a current path occurs due to a low impedance at the intersection between the drive line 101 and the sense line 111, the intersection between the drive line 102 and the sense line 112, and the intersection between the drive line 102 and the sense line 113. Thus, the drive signal for the drive line 101 influences not only the intersections (sensors) of the sense line 111 but also the intersections (sensors) of the sense lines 112 and 113, and the current signals are sensed as if the capacitances changed in the intersection regions other than the region where the floating conductor 61 as an oblong rectangle conductor are placed, for example, the intersection regions (sensor units) between the drive line 101 and the sense lines 112 and 113. Accordingly, the ghost occurs.

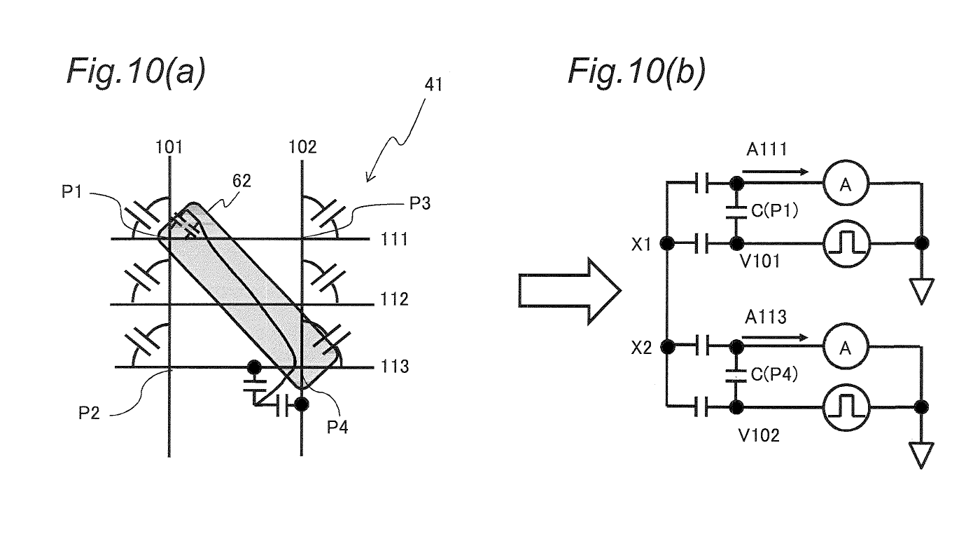

FIG. 10(a) is a schematic diagram that illustrates a planar state where a prescribed floating conductor 62 is placed on one region of the touch panel of the touch-sensor system 4 in FIG. 1, and FIG. 10(b) is an equivalent circuit diagram of a case where the prescribed floating conductor 62 is placed on the capacitive touch-sensor system of the mutual capacitance type.

As illustrated in FIG. 10(a), to simplify the description about a principle of occurrence of the ghost, two intersections P1 and P4 are set as targets. The floating conductor 62 in the oblong rectangle in a plan view is installed on the touch panel 41 while overlapping with the two intersections P1 and P4 on the intersection P1 between the drive line 101 and the sense line 111 and the intersection P4 between the drive line 102 and sense line 113. The principle of occurrence of the ghost in this case will be described.

As illustrated in FIG. 10(b), in a case where a difference occurs between a voltage value V101 of the drive line 101 and a voltage value V102 of the drive line 102, for example, in a case where the voltage value V101 of the drive line 101 is higher than the voltage value V102 of the drive line 102 (V101−V102>0), the current of a current value A111 of the sense line 111 decreases, and the current of a current value A113 of the sense line 113 increases. Thus, the capacitance C of the intersection P1 of the drive line 101 decreases, and the capacitance C of the intersection 22 increases. In brief, the current decreases at the intersection P1 on which the floating conductor 62 is placed, and the current increases at the other intersection P2, resulting in the occurrence of the ghost.

Similarly, in a case where the voltage value V102 of the drive line 102 is higher than the voltage value V101 of the drive line 101 (V101−V102<0), the current of the current value A111 of the sense line 111 increases, and the current of the current value A113 of the sense line 113 decreases. Thus, the capacitance C of the intersection P3 of the drive line 102 increases, and the capacitance C of the intersection P4 of the drive line 102 decreases. In brief, the current decreases at the intersection 24 on which the floating conductor 62 is placed, and the current increases at the other intersection P3, resulting in the occurrence of the ghost.

This is the principle of occurrence of the ghost. A description is made about the ghost due to the interference between the two intersections P1 and P4 (between a position X1 and a position X2). However, in a case where a prescribed shape of the conductive pattern 21 is recognized for identification, signals by more intersections are requested, the intersections at which the interferences occur thereby increase, and the interferences among the intersections become complicated. Thus, correction on a controller side, which is disclosed in related art, and handling by the sensor unit such as the touch panel become difficult.

### (Optimal Design of Virtual Grounding Circuit)

In a case where an object that touches the touch panel 41 and is in the size extending across plural sensor units (for example, the intersections P1 and P4 in FIG. 10(a)) is grounded, the difference between the voltages in the position X1 and the position X2 does not occur as illustrated in FIG. 10(b). That is, the ghost does not occur in this case.

In order to virtually ground the object in the size extending across the plural sensor units (for example, the intersections P1 and P4 in FIG. 10(a)), energy loss may be caused between the position X1 and the position X2 as illustrated in FIG. 10(b), and the change as an increase or a decrease of a prescribed value or more from the reference current signal waveform 42 as illustrated in FIG. 5(b) may be provided. In a case of the mutual capacitance type, a decrease by a prescribed value or more is performed from the reference current signal waveform 42, for example, as the current signal waveform 43.

Here, a description will be made about a design method of the virtual grounding circuit for reducing the occurrence of the ghost and for strongly detecting the capacitance signals to be detected.

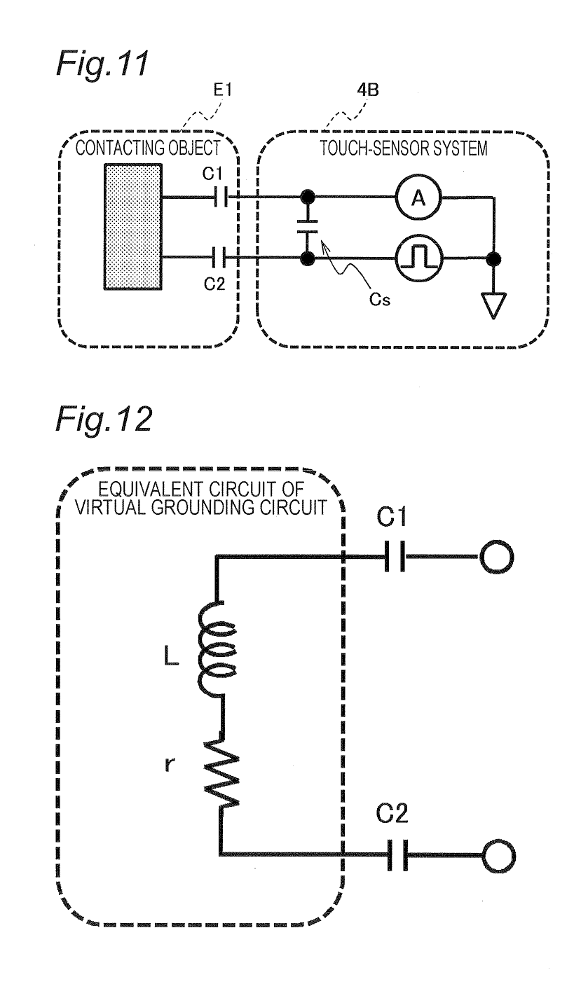

FIG. 11 is an equivalent circuit diagram of a state where a contacting object E1 is placed on the capacitive touch-sensor system 4B of the mutual capacitance type.

As illustrated in FIG. 11, it is assumed that the contacting object E1 is placed on one sensor unit (for example, the intersection P1). A parasitic capacitance Cs is the capacitance of one sensor unit between the drive line (driving line) and the sense line, a contact capacitance C1 is the capacitance between the sense line and the contacting object E1, and a contact capacitance C2 is the capacitance between the contacting object E1 and the drive line (driving line). In this case, an impedance ZE1 that includes the contact capacitances C1 and C2 of the whole circuit due to installation of the contacting object E1 is expressed by a resistance component Ra and a reactance component Xa, and ZE1=Ra+jXa holds.

In order to produce energy loss by the contacting object E1, the resistance component Ra may be increased. As described above, grounding is made because the energy loss becomes larger as the resistance component Ra becomes larger. However, in a case where the impedance 1E1 of the whole circuit is high due to the installation of the contacting object E1, it is difficult for the current to flow through the contacting object E1 because the parallel parasitic capacitance Cs (parallel path) is present. This results in small energy loss in the contacting object E1.

Thus, a series resonance circuit is formed with the contact capacitance C1 and contact capacitance C2 due to the contacting object E1 and the contacting object E1 so as to cause only the resistance component Ra to be present at the drive frequency of the touch-sensor system 4B. This increases the energy loss in the contacting object E1.

FIG. 12 is an equivalent circuit diagram of a case where the virtual grounding circuit is made the series resonance circuit by the contacting object E1 in FIG. 11.

The series resonance circuit formed with the contacting object E1 is an equivalent circuit of the virtual grounding circuit of a series circuit with an r component and an L component and the contact capacitances C1 and C2 on both sides of the series circuit as illustrated in FIG. 12. Given that a joint capacitance of the contact capacitances C1 and C2 due to the contacting object E1 is C′ and the r component and the L component are in series, a joint impedance z of FIG. 12 is

$$z = r + j \sqrt{ω L - \frac{1}{ω {C}^{′}}} \qquad ( 1 )$$

In a case where the series resonance circuit is formed with the contacting object E1, at the resonance frequency, the reactance component on the right side becomes zero, and thus Z=r holds. The impedance z of this circuit becomes the minimum, and the current that flows through the circuit becomes the maximum. In this case, the loss by the consumption in the virtual grounding circuit becomes power P=IMax²×r and becomes the maximum.

On the other hand, in a case where a parallel resonance circuit is formed with the contacting object E1, at the resonance frequency, the impedance z becomes the maximum, and the current that flows through the circuit becomes the minimum. In this case, the loss by the consumption in the virtual grounding circuit becomes power P=Imin²×r and becomes the minimum. That is, in a case where resonance design is performed for the drive frequency of the touch-sensor system 4B, a circuit current does not flow at the drive frequency. Accordingly, the optimal virtual grounding circuit is not the parallel resonance circuit but has to be formed as the series resonance circuit in which the maximum current flows at the resonance frequency.

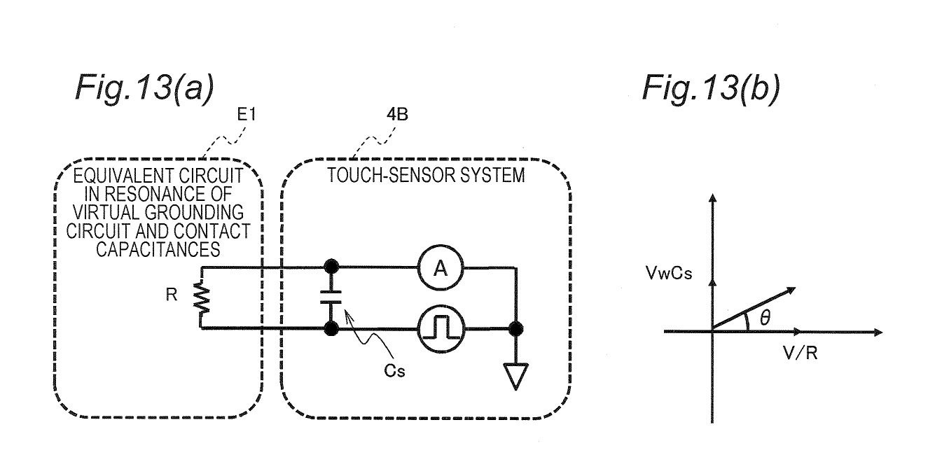

FIG. 13(a) is an equivalent circuit diagram of a case where contact capacitances C1 and C2 and the series resonance circuit (the r component and the L component) are caused to resonate by the contacting object E1 in FIG. 11, and FIG. 13(b) is a diagram that represents the equivalent circuit in FIG. 13(a) by a power factor.

As illustrated in FIG. 13(a), the contact capacitances C1 and C2 and the series resonance circuit (the r component and the L component) are formed by the contacting object E1. However, the equivalent circuit in a case where the resonance design is made for the drive frequency of the touch-sensor system 46 is equivalent to the circuit in which the contact capacitances C1 and C2 and the L component of the series resonance circuit become absent in resonance and only the resistance component (the r component) of the contacting object E1 is connected with both sides of the parasitic capacitance Cs of the drive line (driving line) and the sense line. In this case, effective power that is consumed by the contacting object E1 and the touch-sensor system 46 becomes P=VIcos θ. That is, only the r component is present when cos θ=1, and the contacting object E1 may be caused to consume the highest power P. However, based on FIG. 13(b), because the parasitic capacitance Cs and the resistance component R (the r component) are finite values, the condition to obtain cos θ=1 may not be present unless an inductance component is present. That is, only a small portion of the L component is left because cos θ=1 does not hold unless the inductance component is present. Thus, the contacting object E1 is designed to cancel VoC (voltage×frequency×capacitance) at the drive frequency. In brief, the design is performed so that the contacting object E1 and the contact capacitances C1 and C2 thereof cancel this VoC and cos θ=1 thereby holds.

The impedance of the resonance circuit at a resonance frequency ω₀ becomes formula (2).

$${ω}_{0} L = \frac{1}{{ω}_{0} C} \qquad ( 2 )$$

An operation at a frequency ω₁ that is lower than the resonance frequency ω₀ is represented by formula (3), and thus a capacitive effect is provided. A C component remains in the reactance component.

$${ω}_{1} L < \frac{1}{{ω}_{1} C} \qquad ( 3 )$$

On the other hand, an operation at a frequency ω₂ that is higher than the resonance frequency ω₀ is represented by formula (4), and thus an inductive effect is provided. The L component remains in the reactance component.

$${ω}_{2} L < \frac{1}{{ω}_{2} C} \qquad ( 4 )$$

Because the inductance component (the L component) is requested in order to cancel the VωC, the resonance design of the contacting object E1 is performed for a lower frequency than the drive frequency so that the operation is performed at a higher drive frequency ω₂ than the resonance frequency ω₀. The resonance frequency ω₀ is configured to 400 kHz in a case where the drive frequency is set to 500 kHz, for example, and configuration is thereby made to 0 by canceling ωL by ωC. This is represented by the following formulas (5) to (7).

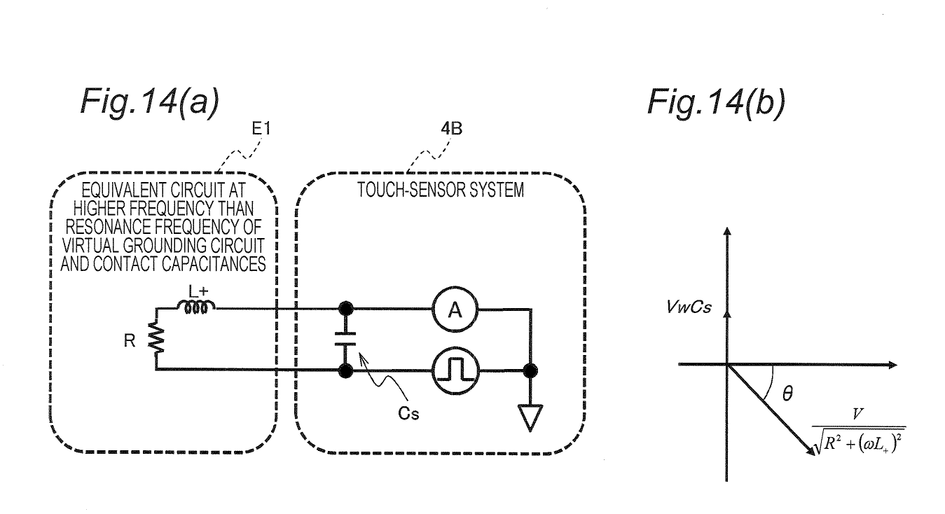

FIG. 14(a) is an equivalent circuit diagram in which FL series circuit components of the contacting object E1 are connected with both of the sides of the parasitic capacitance Cs in a case where the operation is performed at the higher drive frequency ω₂ than the resonance frequency ω₀, and FIG. 14(b) is a diagram that represents the equivalent circuit in FIG. 14(a) by the power factor.

The joint impedance z of the contacting object E1 becomes the following formula (5), and the power factor of the RL series circuit components becomes the following (6).

$$\begin{matrix}\sqrt{{R}^{2} + {( ω {L}_{+} )}^{2}} & ( 5 ) \\ cos θ = \frac{R}{\sqrt{{R}^{2} + {( ω {L}_{+} )}^{2}}} & ( 6 )\end{matrix}$$

Based on FIG. 14(b), the design may be made such that formula (7) holds in order to maximize the effective power that is consumed by the contacting object E1 and the touch-sensor system 4B.

$$V ω Cs = \frac{V}{\sqrt{{R}^{2} + {( ω {L}_{+} )}^{2}}} sin θ \qquad ( 7 )$$

For example, in a case where the contacting object E1 is placed across plural sensors (the intersections P1 and P4) as in FIG. 10(a), the resonance design may be made to include not only the capacitance C1 and C2 (one sensor unit) in FIG. 11 but also related contact capacitances.

So far, a description is made about the virtual grounding circuit that produces the optimal energy loss by the resonance design. However, in a case where the energy loss may not be optimal, a circuit that causes desired energy loss simply at the drive frequency may be formed as the virtual grounding circuit.

In the above, a description is made about a case where the virtual grounding circuit is formed with a passive element (an element that does not have a power source). However, a description will next be made about a case where the virtual grounding circuit is designed with an active element (an element that has a power source).

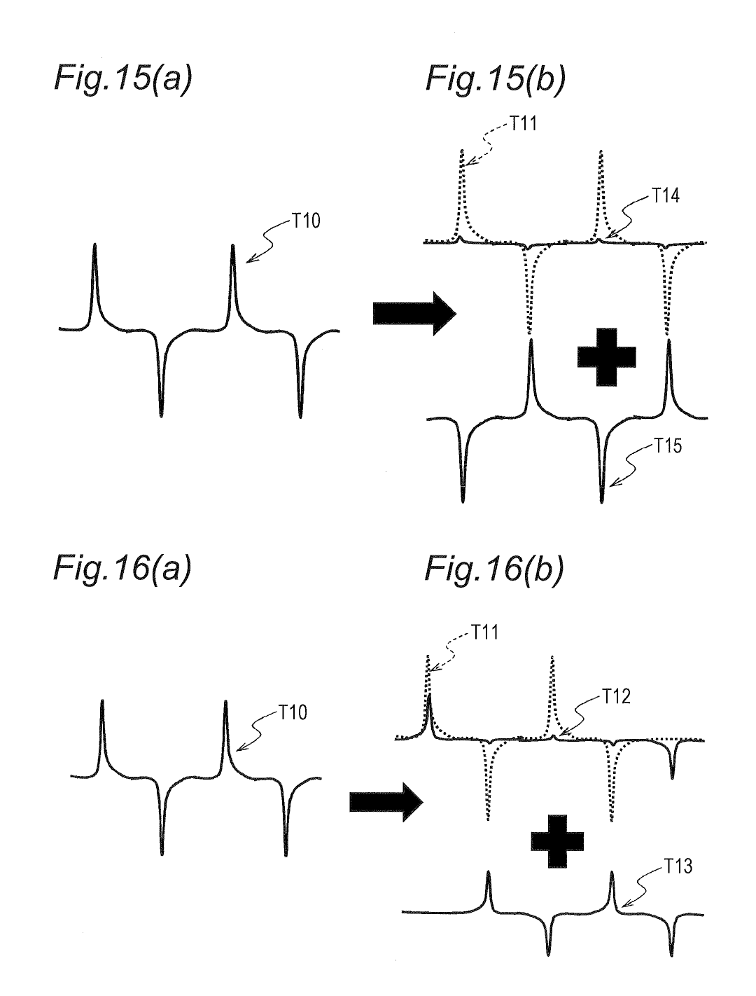

FIGS. 15(a) and 15(b) are current waveform diagrams for explaining a position detection mechanism by signal inversion in a case where the virtual grounding circuit is designed with the active element (the element that has a power source).

As illustrated in FIG. 15(a) and FIG. 15(b), in a case where a drive signal T10 is applied to the drive line and a current signal waveform T11 is obtained as a sense signal waveform from the sense line, an inverted current signal T15 obtained by inverting and amplifying a signal, which is read from the drive signal T10 by the virtual grounding circuit of a stylus, by a power source of the stylus is output from the stylus to a touch screen. The detection is made as drive signal T10 inverted current signal T15=detection signal T14. That is, the design is made such that the inverted current signal T15 obtained by inverting and amplifying the signal, which is read from the drive signal T10 by the virtual grounding circuit, by the virtual grounding circuit is output from the stylus to the touch screen. A signal read from the sensor unit changes such that the level lowers from the current signal waveform T11 as a reference in a case where nothing contacts with the sensor unit to the detection signal T14. In this case, the changed signal amount becomes large, and the capacitance signal may thus be largely detected. Thus the position detection by the stylus is facilitated.

FIGS. 16(a) and 16(b) are current waveform diagrams for explaining a position detection mechanism by phase delay in a case where the virtual grounding circuit is designed with the active element (the element that has a power source).

As illustrated in FIG. 16(a) and FIG. 16(b), in a case where a drive signal that has three values like the drive signal T10 is applied and where the design is made such that a phase delay signal T13 in which the phase of the signal read from the drive signal T10 by the virtual grounding circuit of the stylus is delayed by half the wavelength by the virtual grounding circuit is output from the stylus to the touch screen, a signal read from the sensor unit (an intersection portion) changes such that the level lowers from the current signal waveform T11 as the reference in a case where nothing contacts with the sensor unit to a detection signal T12. In this case, the changed signal amount becomes large, and the capacitance signal may thus be largely detected.

A method described above of performing the position detection by signal inversion or phase delay by the active element (the element that has a power source) enables the change in the capacitance signal to be strongly detected. However, the drive signal of a touch panel system 4 is a different signal with respect to each of the driving and sensing. Thus, in a case where the contacting object E1 widely makes contact across plural sense lines, the phase of the signal waveform of each of the drive lines (driving lines) has to be delayed by half the wavelength, or the signal waveform has to be inverted. That is, the design has to be made such that as for the signal, the current signal at a point on a lattice with the same intervals as the touch panel system 4 is read by a plane and the signal is output at the point on the lattice with the same intervals as the touch panel system 4.

The first embodiment supposes a method of reducing the interference itself that is referred to as ghost and of increasing the change in the capacitance signal to be detected. In a description made below, effects thereof will be described.

### (Effects of Reducing Interference Itself Referred to as Ghost)

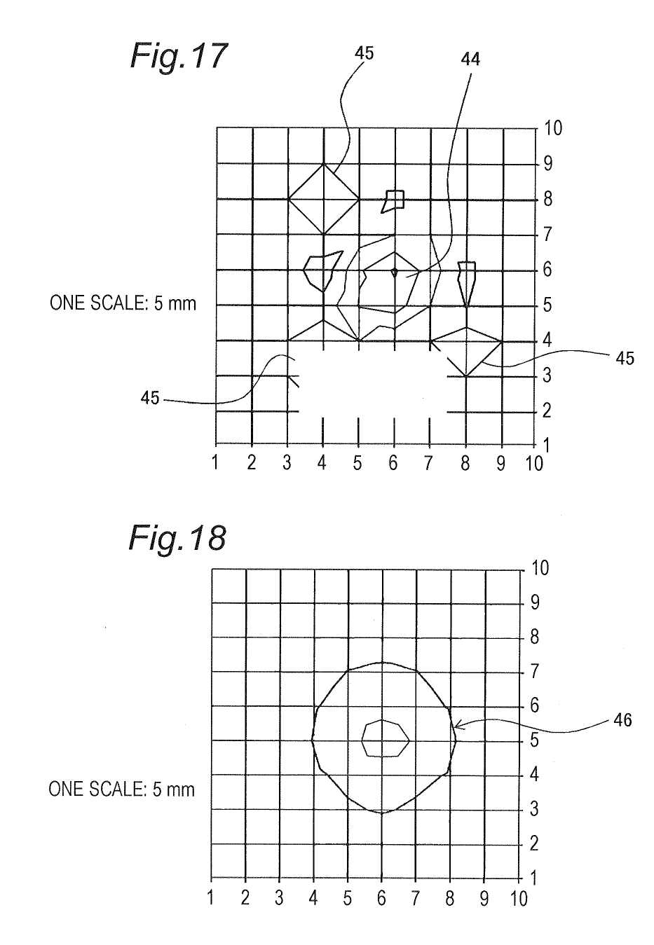

FIG. 17 is a plan view that illustrates a detection example of the conductive pattern 21 in a case where the conductive pattern 21 in a circular shape with a diameter of 20 mm is alone placed on the touch panel 41 of the touch-sensor system 4 in FIG. 1.

FIG. 17 illustrates a capacitance signal map that is obtained from the sensors in a state where the conductive pattern 21 in the circular shape with a diameter of 20 mm alone contacts with the touch panel 41 of the touch-sensor system 4 without mounting the virtual grounding circuit unit 3. The conductive pattern 21 in the circular shape with a diameter of 20 mm is alone used for the conductive pattern unit 2. The interval of the lattice is an interval of 5 mm. A capacitance signal region 45 is detected due to a ghost pattern around a capacitance signal region 44 in addition to the capacitance signal region 44 by the conductive pattern 21 in the circular shape at the center. Based on this, a description will be made about a detection example in a case where the virtual grounding circuit unit 3 is connected with the conductive pattern 21 in the circular shape with a diameter of 20 mm alone, as an effect of the first embodiment, with reference to FIG. 18.

FIG. 18 is a plan view that illustrates a detection example of the conductive pattern 21 in a case where the conductive pattern 21 in the circular shape with a diameter of 20 mm and the virtual grounding circuit 3 are placed on the touch panel 41 of the touch-sensor system 4 in FIG. 1.

FIG. 18 illustrates a capacitance signal map that is obtained from the sensors in a state where the virtual grounding circuit unit 3 is connected with and mounted on the conductive pattern 21 and the conductive pattern 21 in the circular shape with a diameter of 20 mm contacts with the touch panel 41 of the touch-sensor system 4. The virtual grounding circuit unit 3 is connected with the conductive pattern 21 of the conductive pattern unit 2, and a signal for detecting the conductive pattern 21 of the conductive pattern unit 2 is thereby stabilized. Accordingly, the occurrence of the ghost may be reduced, and a capacitance signal region 46 in a circular shape may accurately be read with the equivalent size and shape to the size of the conductive pattern unit 2. As described above, the ghost is rectified on the identifying body 1 side, and the shape of the identifying body 1 as seen from the touch panel surface may thereby be detected more accurately.

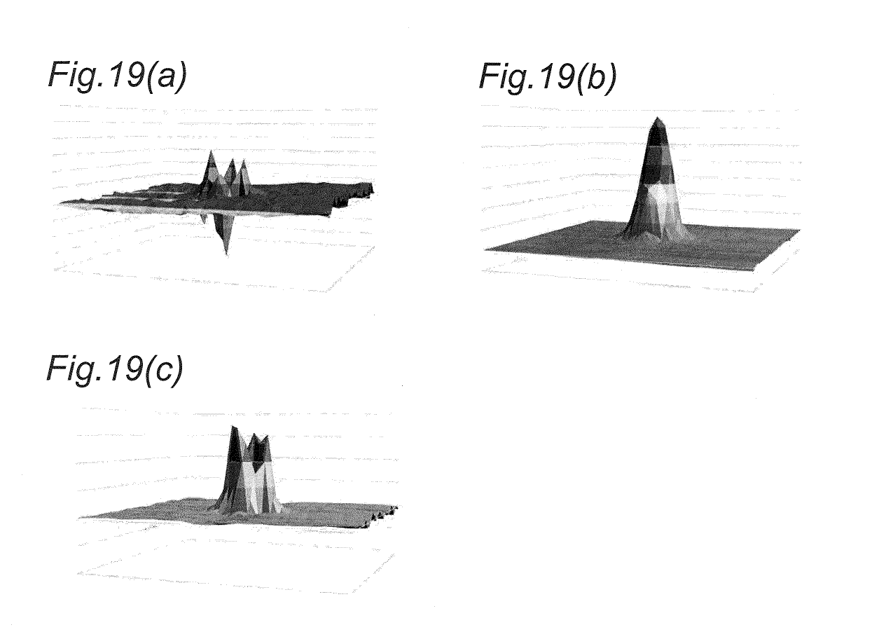

FIG. 19 is capacitance signal distribution diagrams of the conductive pattern 21 in the circular shape, FIG. 19(a) is a capacitance signal distribution diagram in a floating state, FIG. 19(b) is a capacitance signal distribution diagram in a ground state, and FIG. 19(c) is a capacitance signal distribution diagram of virtual grounding by a monopole antenna as the series resonance circuit.

Because the number of the intersections for the conductive pattern 21 in the circular shape with a diameter of 20 mm which is mounted on the touch panel 41 whose lattice interval (sensor pitch) is 5 mm is at least 10 points in this case, correction calculation as in related art is difficult. Here, the ghost is rectified by virtual grounding on the identifying body 1 side, and the shape of the conductive pattern 21 of the identifying body 1 as seen from the screen of the touch panel 41 may thereby be detected more accurately. In FIG. 19(a), identification of the circular shape is difficult in the floating state. In FIG. 19(b), identification of the circular shape is possible because of the ground state by grounding to a USB port. In FIG. 19(c), identification of the circular shape is possible by virtual grounding to the monopole antenna. Further, virtual grounding may compactly be made in a case of a planar antenna such as a patch antenna.

As described above, in the first embodiment, there are provided the conductive pattern unit 2 in which the conductive pattern 21 as the shape to be recognized by the touch-sensor system 4 by contacting with or adjoining a surface of the touch panel 41 of the touch-sensor system 4 is arranged and the virtual grounding circuit unit that is connected with the conductive pattern 21 of the conductive pattern unit 2 and has an energy loss unit which consumes energy with respect to the frequency of the drive signal (which is applied to the drive line) used in the touch-sensor system 4.

Accordingly, the energy loss unit consumes energy with respect to the frequency of the drive signal used in the touch-sensor system, and even in a case of the identifying body 1 (the indicating body) that is not grounded, the identifying body 1 (the indicating body) is virtually grounded and thereby has an equivalent function to the ground circuit. Thus, differently from related art in which the ghost is corrected on the controller side of the touch-sensor system 4 or the ghost is distinguished from a real touch by the sensor unit, the ghost is rectified on the identifying body 1 side, and the shape of the identifying body 1 as seen from the surface of the touch panel 41 may thereby be detected more accurately. Thus, the touch-sensor system 4 may be applied as an identifying tool for the user authentication and so forth and may thereby be used for security authentication systems illustrated in FIG. 3, amusement purposes, and so forth.

In the first embodiment, because changes are not added to the structure of the touch-sensor system 4, touch performance of the existing touch-sensor system 4 is not influenced. This results in usefulness because identification of a region shape as well as identification of a touch position may be performed by simultaneous use of the finger touch, the stylus, and the identifying body 1.

In the first embodiment, a description is made about the identifying body 1 for a touch-sensor system that is used for the capacitive touch-sensor system 4 and detects shapes. However, the first embodiment may be applied for inhibiting the ghost in cases of shape detection types of the touch-sensor system 4 in which the ghost occurs.

### Second Embodiment

In the second embodiment, a description will be made about a case where a circuit of a coil 321 or an antenna 325, which will be described later, is used as specific examples of the ground compensating circuit unit 32 that has an equivalent function to the ground circuit for the conductive pattern 21.

First, a description will be made about a case where a coil circuit of the coil 321 described later is used as a specific example of the ground compensating circuit unit 32.

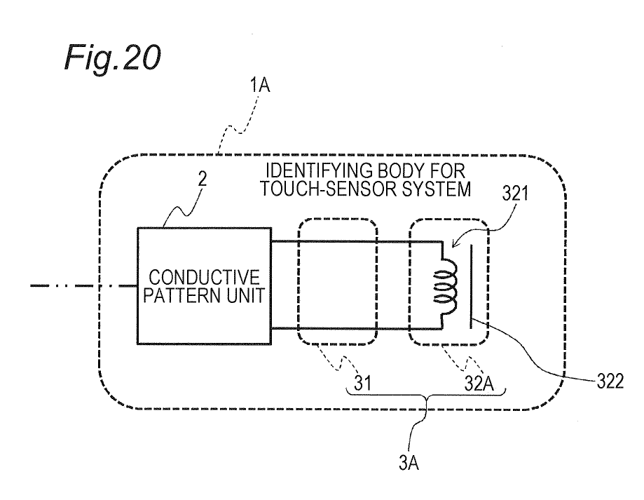

FIG. 20 is a block diagram that illustrates a configuration example of an identifying body 1A for a touch-sensor system in the second embodiment of the present invention.

In FIG. 20, the identifying body 1A for a touch-sensor system of the second embodiment includes the conductive pattern unit 2 in which the conductive pattern 21 in a prescribed shape is arranged to be opposed to the screen of the touch panel and a virtual grounding circuit unit 3A that has an equivalent function to the ground circuit for the conductive pattern 21, is installed on the touch panel surface of the touch-sensor system 4 that enables the position input operation of the indicating body such as a finger, and is used for the user authentication and so forth. In brief, the identifying body 1A for a touch-sensor system contacts with or approaches the touch panel surface of the touch-sensor system 4 that enables the position input operation of the indicating body such as a finger, and the conductive pattern 21 in a prescribed shape, which is not grounded, is thereby caused to become the virtual ground state, thereby enabling reading by the touch-sensor system 4.

The virtual grounding circuit unit 3A has the conductive pattern connection unit 31 and the ground compensating circuit unit 32A that is connected with the conductive pattern 21 of the conductive pattern unit 2 via the conductive pattern connection unit 31. The coil 321 is used as the ground compensating circuit unit 32A such that the conductive pattern 21 works in a similar manner to the grounded state. Here, although not illustrated, the coil circuit that includes one or plural coils 321 is used to form the series resonance circuit with the touch-sensor system at a drive signal frequency of the touch-sensor system 4 and to mount a coil with large energy loss with respect to the drive signal frequency (a coil that works in a similar manner to the grounded state).

As for a first specific example of the virtual grounding circuit unit 3 that reduces the ghost, the coil 321 is mounted on the ground compensating circuit unit 32A as the energy loss circuit (grounding circuit) with respect to the frequency of the drive signal (the alternate current signal that drives the drive line) of the touch-sensor system 4, and a conductor 322 is arranged around the coil 321. The conductor 322 is not limited to iron but may be aluminum or the like and acts as an iron core or a core. Accordingly, the conductor 322 works equivalently to the ground circuit. The conductor 322 actively facilitates eddy-current loss in the coil 321 and thereby performs stronger grounding.

The coil 321 is requested not to respond to the touch-sensor system 4 because the coil 321 is a conductor. However, in a case where the surface of the conductive pattern 21 of the conductive pattern unit 2 that is opposed to the sensor surface (the touch panel surface) of the touch panel 41 is a flat plane, a member in which the conductive pattern unit 2 is arranged is not grounded and further responds to the touch-sensor. A shield process such as a Faraday shield may not be implemented. Thus, the conductive pattern connection unit 31 has to have a wiring configuration in which a sufficient distance is provided between the coil 321 and the sensor surface. The conductor 322 is mounted around the coil 321 in order to increase the eddy-current loss in the coil 321. The conductor 322 has to be configured not to respond to the touch-sensor system 4.

Next, a description will be made about the wiring configuration in which the sufficient distance is provided between the coil 321 (inductance) and the sensor surface in order to obtain a configuration that does not respond to the touch-sensor system 4.

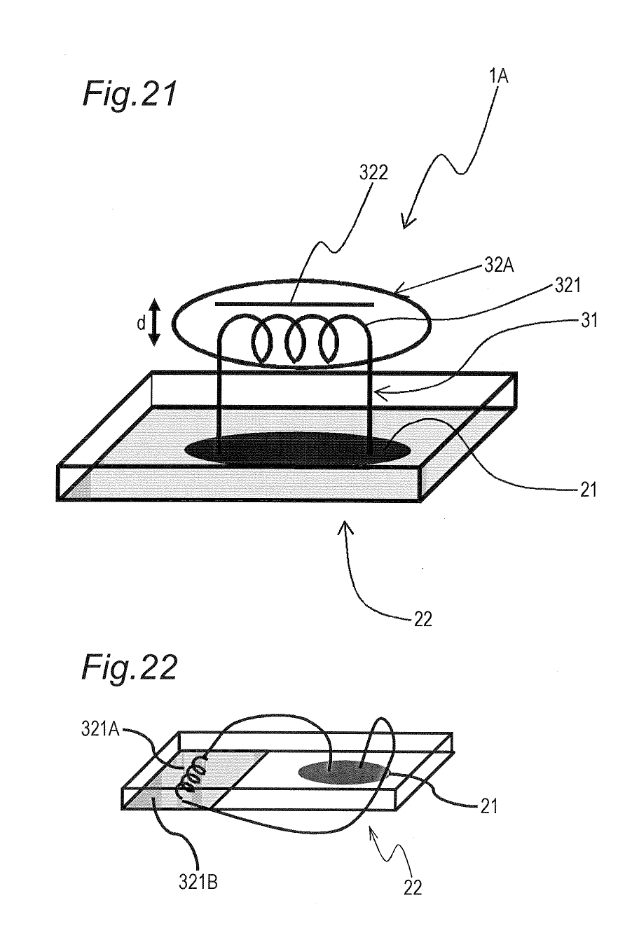

FIG. 21 is a perspective view that schematically illustrates a specific example of the identifying body 1A for a touch-sensor system in the second embodiment of the present invention.

As illustrated in FIG. 21, the conductive pattern 21 is provided on a bottom surface 22 of a plate-like body with a thickness and in a rectangle in a plan view by printing, evaporation, or the like. In a state where the coil 321 is connected with the conductive pattern 21 and separated only by a prescribed distance immediately above that, the coil 321 and the conductor 322 around that are arranged as the ground compensating circuit unit 32A. The bottom surface 22 of the plate-like body on which the conductive pattern 21 is formed is placed on the touch panel surface of the touch-sensor system 4.

As described above, because the ground compensating circuit unit 32A that has the coil 321 and the conductor 322 is a conductor, so that the ground compensating circuit unit 32A does not respond to the touch-sensor system 4, the sufficient distance has to be provided between the ground compensating circuit unit 32A that has the coil 321 and the conductor 322 and the sensor surface. The thickness of the plate-like body which has the conductive pattern 21 formed on its bottom surface 22 may be made thicker (for example, 10 mm or more; no influence of false detection occurs in a case of the separation by 10 mm). The ground compensating circuit unit 32A may be arranged such that ground compensating circuit unit 32A stands to be separated only by the distance in which no response occurs to the touch-sensor system 4 (for example, 10 mm or more) via the conductive pattern connection unit 31 (here, the ground compensating circuit unit 32A is lifted by the wiring).

Further, a non-conductive magnetic shield such as ferrite (magnet material) may be provided on the wiring of the conductive pattern connection unit 31 or an upper surface side of the plate-like body. Further, a thickness d in the vertical direction of the ground compensating circuit unit 32A (the thickness in the distance direction with respect to the touch panel surface) is made less thicker, and the conductive ground compensating circuit unit 32A may thereby be caused to be less likely to respond to the touch-sensor system 4.

FIG. 22 is a perspective view that schematically illustrates another specific example of the identifying body 1A for a touch-sensor system in the second embodiment of the present invention.

As illustrated in FIG. 22, the conductive pattern 21 is provided on the bottom surface 22 of the plate-like body (which may be card-like) in the rectangle in a plan view by printing, evaporation, or the like. In a state where a coil 321A is connected with the conductive pattern 21 and integrally adjoined thereto on an immediate lateral side, the coil 321A is arranged as another example of the ground compensating circuit unit 32A. The bottom surface 22 of the plate-like body on which the conductive pattern 21 is formed is placed on the touch panel surface of the touch-sensor system 4. Note that the coil 321A and a conductor around that may be arranged instead of the coil 321A as the grounding circuit.

A response (position detection) due to a touch other than the size of a region 321B in which the coil 321A is arranged is accepted, and an interference with a shape detection with respect to the conductive pattern 21 may thereby be inhibited. That is, the detection of the region 321B in which the coil 321A is arranged is not employed, and the interference with the shape detection of the conductive pattern 21 may thereby be inhibited. For example, in a case where the identifying body 1A for a touch-sensor system is installed in a processing position on the touch panel 41 of the touch-sensor system 4 and where the installing direction is specified while the front and the back are defined, a detection result on a left side region (the region 321B in which the coil 321A is arranged) of the identifying body 1A for a touch-sensor system may not be employed and easily be discarded. Alternatively, a detection result in a strip shape as seen from the sensor surface of the coil 321A, which is other than the shape of the conductive pattern 21, may not be employed and easily be discarded. In those cases, the coil 321A may be mounted while the distance of the coil 321A as the ground compensating circuit unit 32A is not separated above from the sensor surface of the touch-sensor system 4. Accordingly, the plate-like body in the rectangle in a plan view may be thinly formed as a code identifying card for a touch-sensor system in a card shape as the other specific example of the identifying body 1A for a touch-sensor system.

Next, a description will be made about a case where the antenna 325 is realized by a coil 323 that will be described later as a specific example of the ground compensating circuit unit 32 and an antenna circuit that has the antenna 325 is used.

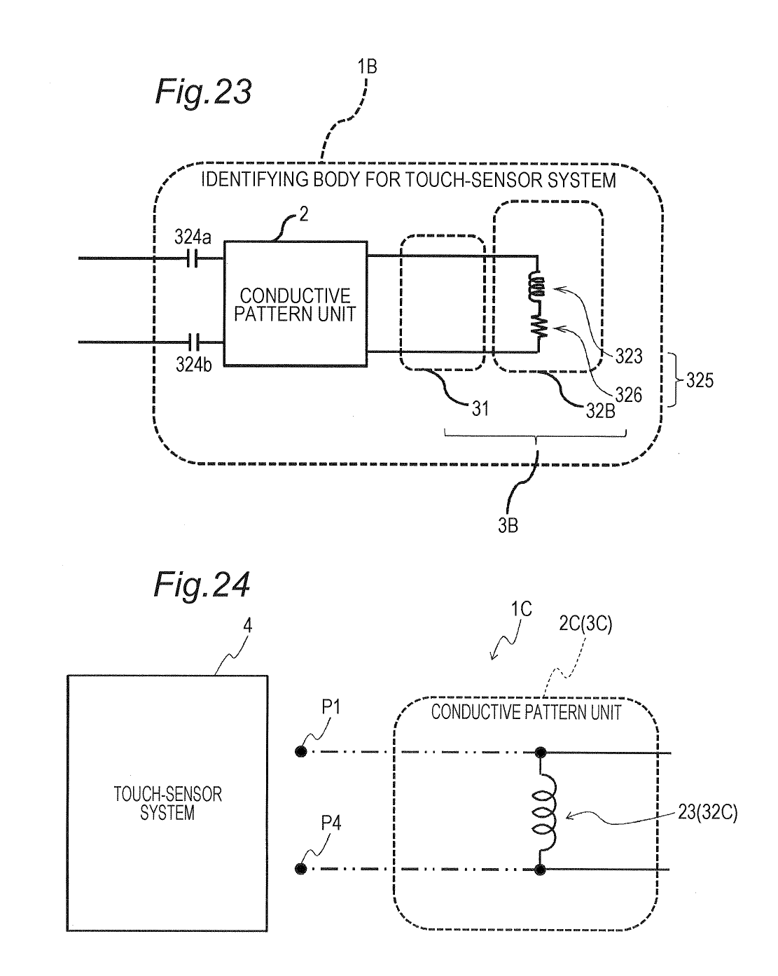

FIG. 23 is a block diagram that illustrates a configuration example of an identifying body 1B for a touch-sensor system in the second embodiment of the present invention.

In FIG. 23, the identifying body 1B for a touch-sensor system in another configuration example of the second embodiment includes the conductive pattern unit 2 in which the conductive pattern 21 in a prescribed shape is arranged to be opposed to the screen of the touch panel and a virtual grounding circuit unit 3B that has an equivalent function to the ground circuit for the conductive pattern 21, is installed on the touch panel surface of the touch-sensor system 4 that enables the position input operation of the indicating body such as a finger (a grounded indicating body), and is used for the user authentication and so forth. In brief, the identifying body 1B for a touch-sensor system that has the virtual grounding circuit unit 33 contacts with or approaches the touch panel surface of the touch-sensor system 4 that enables the position input operation of the indicating body such as a finger, and the conductive pattern 21 in a prescribed shape, which is not grounded, is thereby caused to become the virtual ground state, thereby enabling reading by the touch-sensor system 4.

The virtual grounding circuit unit 3B has the conductive pattern connection unit 31 and a ground compensating circuit unit 323 that is connected with the conductive pattern 21 of a conductive coat pattern unit 2 via the conductive pattern connection unit 31. The antenna 325 is realized by the coil 323 and a loss resistance component 326 as the ground compensating circuit unit 32B such that the conductive pattern 21 works in a similar manner to the grounded state, and the antenna circuit that has those is used. The antenna 325 that targets the drive signal frequency of the touch-sensor system 4 is mounted. Strong grounding may be made by the antenna 325.

The ground compensating circuit unit 325 is realized by the antenna 325. The antenna 325 is equivalently formed with the coil 323 and the loss resistance component 326. The coil 323, the loss resistance component 326, and contact capacitance 324a and 324b form the series resonance circuit. Because of the series resonance circuit, a loop is equivalently formed in FIG. 23. However, a closed loop does not actually have to be formed.

In order to make the antenna circuit the ground compensating circuit unit 325, the antenna circuit is preferably configured to resonate with the frequency of the drive signal of the touch-sensor system 4. Because the resonance wavelength with respect to the drive frequency of the touch-sensor system 4 exceeds the meter order, a micro-antenna that is shorter than the resonance wavelength is used. Thus, radiation is facilitated as the size of the antenna 325 is larger. However, because the size of the mountable antenna 325 is decided in accordance with the size of the identifying body 1B for a touch-sensor system, a capacitor and an inductor may be connected together in series to compensate the coil 323 as the inductance component of the antenna 325 and the contact capacitances 324a and 324b. In a case where the antenna circuit is used as the ground compensating circuit unit 32B, a large current preferably flows through the antenna circuit in order to enhance propagation of radio waves. Thus, the design is preferably made such that the impedance of a whole virtual grounding circuit 3B becomes low and the effective power of the whole virtual grounding circuit 3B becomes high. Although not illustrated here, the antenna 325 actually has a capacitance component, and the conductive pattern connection unit 31 and the conductive pattern unit 2 also have the capacitance components, the inductor components, and the resistance components. The design actually has to be made in consideration thereof.

In a case of the antenna circuit, similarly to a case of the coil, a configuration is possible in which the distance is provided to the antenna circuit by causing the conductive pattern connection unit 31 to stand so that the antenna circuit does not respond to the touch-sensor system 4 or the antenna circuit is arranged next to the conductive pattern 21 along the plane thereof to cancel the response. In brief, the antenna circuit of the ground compensating circuit unit 32B may be used instead of the coil circuit of the coil 321 of the ground compensating circuit unit 32A or the coil circuit of the coil 321A in FIG. 21 or 22. Although not limited to this, the antenna circuit of the ground compensating circuit unit 32B may be used together with the coil circuit of the coil 321 of the ground compensating circuit unit 32A or the coil circuit of the coil 321A in FIG. 21 or 22.

As described above, in the second embodiment, the coil circuit that uses the coil 321 or 321A and/or the antenna circuit is used as the ground compensating circuit unit 32B that is connected with the conductive pattern 21 of the conductive pattern unit 2 via the conductive pattern connection unit 31 and thereby has the equivalent function to a case where the ground circuit is used for the conductive pattern 21. Accordingly, differently from related art in which the ghost is corrected on the controller side of the touch-sensor system 4 or the ghost is distinguished from a real touch by the sensor unit, the ghost is rectified on the identifying body 1A or 1B side. Accordingly, the shapes of the identifying bodies 1A and 1B as seen from the touch panel surface may more accurately be detected, and the capacitance signal to be detected may more strongly be detected. Thus, the touch-sensor system 4 may be applied as the identifying tool for the user authentication and so forth and may thereby be used for security authentication systems illustrated in FIG. 3, amusement purposes, and so forth.

In the second embodiment, because changes are not added to the structure of the touch-sensor system 4, the touch performance of the existing touch-sensor system 4 is not influenced. This results in usefulness because the touch position and the shapes of the identifying bodies 1A and 1B may be identified by simultaneous use of the finger touch, the stylus, and so forth and the identifying bodies 1A and 1B.

In the second embodiment, a description is made about the identifying body 1A or 1B for a touch-sensor system that is used for the capacitive touch-sensor system 4 and for detecting prescribed shapes. However, the second embodiment may be used for applications for inhibiting the ghost and increasing the detection signal in cases of shape detection types of the touch-sensor system in which the ghost occurs.

In the second embodiment, the conductor 322 is arranged around the coil 321. However, only the coil 321 may simply be provided as long as the equivalent function to a case where the ground circuit is used for the conductive pattern 21 is provided.

In the second embodiment, a description is made about the ground compensating circuit unit 320 that uses the coil circuits and/or the antenna circuit. However, an element that uses a skin effect by using an iron plate and so forth or an element that uses dielectric loss by using a high-dielectric material is possible as an element that produces the energy loss which realizes the ground compensating circuit unit 32B.

### Third Embodiment

In the third embodiment, a description will be made about a case where a conductive pattern 23 of a conductive pattern unit 2C is configured by using a ground compensating circuit unit 32C that has a coil circuit or an antenna circuit of a conductive body in order to avoid the response of the ground compensating circuit unit 32C to the touch-sensor system 4. In brief, this is a case where the conductive pattern itself is configured with the coil circuit or the antenna circuit of the conductive body.

FIG. 24 is a block diagram that illustrates a configuration example of an identifying body for a touch-sensor system in the third embodiment of the present invention.

In FIG. 24, in the identifying body 1C for a touch-sensor system of the third embodiment, the conductive pattern 23 in a prescribed shape is arranged to be opposed to the touch panel surface of the touch-sensor system 4 that enables the position input operation of the indicating body such as a finger, and a virtual grounding circuit unit 3C that has an equivalent function to the ground circuit for the conductive pattern 23 is provided as the conductive pattern unit 2C. In brief, the identifying body 10 for a touch-sensor system contacts with or approaches the touch panel surface of the touch-sensor system 4 that enables the position input operation of the indicating body such as a finger, and the conductive pattern 23 in a prescribed shape, which is not grounded, is thereby caused to become the virtual ground state, thereby enabling reading by the touch-sensor system 4.

As one specific example of the conductive pattern unit 2C that reduces the ghost, the conductive pattern 23 that has high impedance with respect to the alternate current is configured in a state of having the function of the ground compensating circuit unit 32C. The conductive pattern 23 is realized as a structure in which the direct current resistance is low so that the conductive pattern 23 responds to the touch-sensor system 4 and the inductance component of the conductive pattern 23 is large so that the interference between the sensors are reduced. Thus, a coil that is caused to contact with the touch-sensor system 4, for example, that has the inductance component coupled between the different intersections P1 and P4 is arranged. This coil is provided as the conductive pattern 23 on a surface of the identifying body 1C for a touch-sensor system, which is opposed to the touch panel surface. In a high-frequency range, the inductance component may be increased by micro-stripline, a stub structure, a small-sized coil element, and so forth.

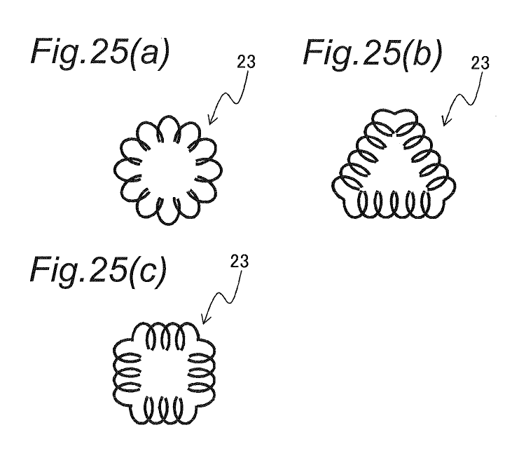

FIGS. 25(a) to 25(c) are respective plan views that schematically illustrate external shape examples of the conductive patterns 23 formed of the coils.

In FIG. 25(a), the coil is arranged to be opposed to the touch panel surface of the touch-sensor system 4 such that the external shape of the conductive pattern 23 in a plan view becomes a circular shape. In FIG. 25(b), the coil is formed such that the external shape of the conductive pattern 23 in a plan view becomes a triangle. In FIG. 25(c), the coil is formed such that the external shape of the conductive pattern 23 in a plan view becomes a rectangle. Incidentally, in FIG. 24, the coil in which the external shape of the conductive pattern 23 in a plan view is a strip shape in the longitudinal direction is arranged to be opposed to the touch panel surface of the touch-sensor system 4.

Central portions of the conductive patterns 23 that are formed with those coils are not detected in a case where the detection region expands, but the external shapes are detected by prescribed widths. In a case where the detection of the central portion is requested, the coil may be provided in the central portion. In order to reduce the occurrence of the ghost, a configuration may be made to increase the inductance component without increasing the direct current resistance.

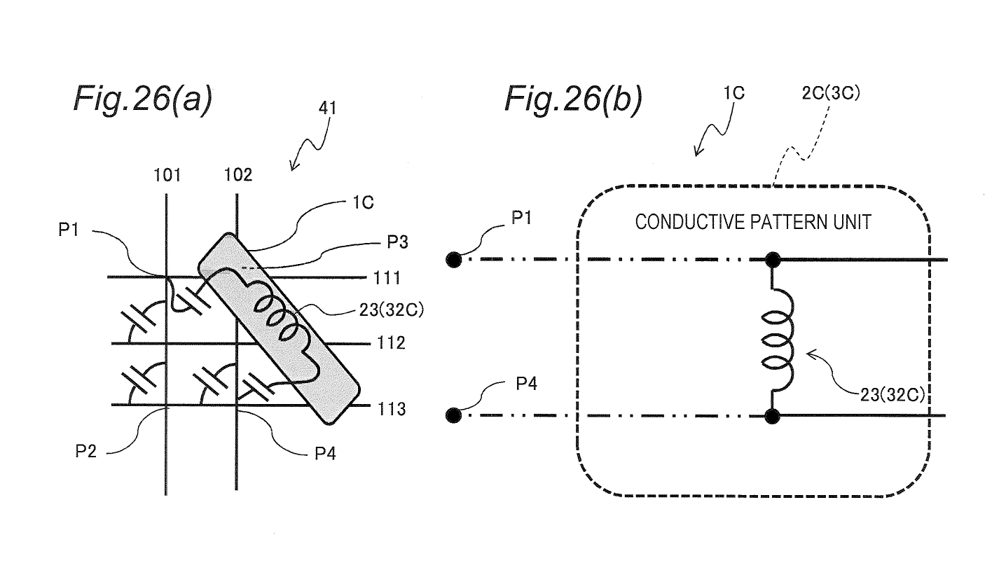

FIG. 26(a) is a schematic diagram that illustrates a planar state where the identifying body 10 for a touch-sensor system with a prescribed conductive pattern 23 is placed on one region of the touch panel 41 of the touch-sensor system 4 in FIG. 1, and FIG. 26(b) is a block diagram that illustrates a configuration example of the identifying body 10 for a touch-sensor system in FIG. 26(a). Here, FIG. 26(b) is equivalent to FIG. 24. Further, in FIG. 26(a), the identifying body 10 for a touch-sensor system is placed across the intersections P1 and P4 of the touch panel 41 of the touch-sensor system 4. However, here, the identifying body 1C for a touch-sensor system is illustrated while being offset to an oblique upper right position for easier understanding of the equivalent circuit.

As illustrated in FIG. 26(a), the identifying body 10 for a touch-sensor system in an oblong rectangle in a plan view is installed on the touch panel 41 while overlapping with the two intersections P1 and P4 on the intersection P1 between the drive line 101 and the sense line 111 and the intersection P4 between the drive line 102 and sense line 113. An equivalent circuit in this case is illustrated.

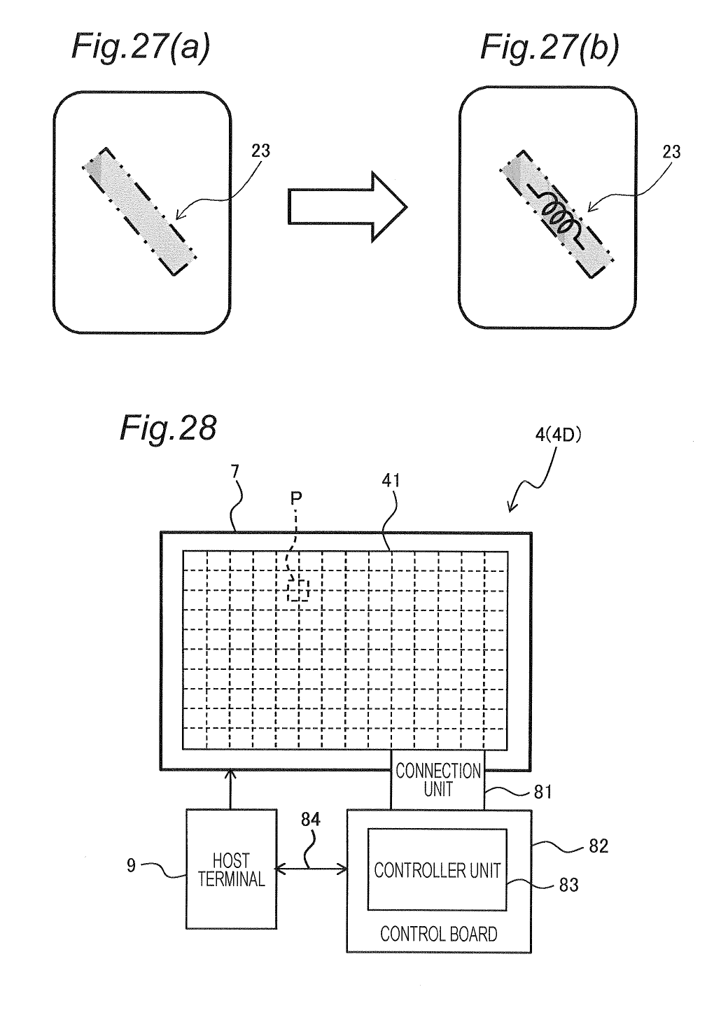

FIGS. 27(a) and 27(b) are plan views that schematically illustrate the conductive pattern 23.

As illustrated in FIG. 27(a) and FIG. 27(b), in order to cause the response (shape detection) to the touch-sensor system 4, a coil may be configured with a conductive material and may be formed in various shapes such as an oblique strip shape as the shape in a plan view of the conductive pattern 23 as seen from the screen of the touch panel 41.

As described above, in the third embodiment, the conductive pattern 23 itself of the conductive pattern unit 2C is formed with the coil, thereby providing an equivalent function to a case of using the ground circuit for the conductive pattern 23. Accordingly, differently from related art in which the ghost is corrected on the controller side of the touch-sensor system 4 or the ghost is distinguished from a real touch by the sensor unit, the ghost is rectified on the identifying body 1C side. Thus, the shape of the identifying body 1C as seen from the touch panel surface may more accurately be detected. Thus, the touch-sensor system 4 may be applied as the identifying tool for the user authentication and so forth and may thereby be used for the security authentication systems illustrated in FIG. 3, amusement purposes, and so forth.

In the third embodiment, because changes are not added to the structure of the touch-sensor system 4, the touch performance of the existing touch-sensor system 4 is not influenced. This results in usefulness because identification of a touch position and a touch shape may be performed by simultaneous use of the finger touch, the stylus, and the identifying body 10.

In the third embodiment, a description is made about the identifying body 10 for a touch-sensor system that is used for the capacitive touch-sensor system 4 and detects shapes. However, the third embodiment may be applied for inhibiting the ghost in cases of shape detection types of the touch-sensor system in which the ghost occurs.

In the third embodiment, the coil is arranged. However, a coil circuit of a conductor may be provided to or around the coil so that an equivalent function to a case where the ground circuit is used for the conductive pattern 23 is provided. Together with that or separately from that, an antenna circuit may be provided. An electromagnetic wave absorber material may be used for the conductive pattern 23 as a material that produces the energy loss at the drive frequency of the touch panel. The radar absorbent here represents a so-called shielding material that converts the alternate current signal at the drive frequency of the touch panel into heat or the like.

### Fourth Embodiment

In the fourth embodiment, a description will be made about a case of configuring a touch-sensor system 40 that includes at least any of the identifying bodies 1 and 1A to 1C for a touch-sensor system of the above first to third embodiments and a touch-sensor system 4 that corresponds thereto.

FIG. 28 is a block diagram that illustrates an overall configuration example of the touch-sensor system 4 in the fourth embodiment of the present invention.

In FIG. 28, the touch-sensor system 4 of the fourth embodiment 4 has a display device 7 that has a display screen for image display, the touch panel 41 for the position detection that is provided on the display screen, a connection unit 81 of flexible printed circuits (FPC) that is connected with the touch panel 41, a control board 82 that is connected with the connection unit 81, a controller unit 83 that is installed on the control board 82 and performs a position detection control process, a connection cable 84 that is connected with the controller unit 83 via the control board 82, and a host terminal 9 that is connected with the controller unit 83 via the connection cable 84, is connected with the display device 7, and controls display of the display device 7.

The touch panel 41 is provided along and mutually in parallel with the touch panel surface, has plural drive lines to which respective drive signals are provided, and further has plural sense lines that are provided along the touch panel surface and in parallel with each other so as to intersect the plural drive lines (three-dimensional intersection; vertical intersection or intersection at the other angles). The touch panel 41 may output an output signal in accordance with the change in the capacitance by the indicating body that contacts with or adjoins the touch panel 41 (the finger, the stylus, at least any of the identifying bodies 1 and 1A to 1C for a touch-sensor system of the above first to third embodiments, and so forth). Plural output signals from the plural sense lines are signals that are output via the intersections P between the drive lines and the sense lines (both indicated by broken lines) in the touch panel surface and close portions to the intersections P, due to driving of the drive lines.

The signal from a sense line St changes in a case where the indicating body such as the finger or the stylus contacts with or adjoins the touch panel surface. That is, the signal obtained by the sense line serves as a signal that indicates a position information (x, y) of a two-dimensional detection region E which indicates presence or absence of contact with or adjoining to an indication detection region and three-dimensional coordinate information which indicates capacitance information (z) by the indicating body. As a Z value of the capacitance information (z) becomes smaller, the signal level that indicates the capacitance value becomes lower.

The display device 7 may be a liquid crystal display (liquid crystal display device), a plasma display, an organic EL display, a field emission display, and so forth, for example, or a device that displays an image on the display screen.

The controller unit 83 drives the drive lines and processes the signals from the sense lines to detect the touch position or the touch shape (the detection region of the conductive pattern) of the indicating body in the touch panel surface.

The host terminal 9 is configured with a personal computer or the like, controls the controller unit 83 via the connection cable 84, and enables display control of an image displayed on the display screen of the display device 7 based on the position of the indicating body that is detected by the controller unit 83 (the position information (x, y) of a touch indication detection region) and the capacitance information (z).

Further, the host terminal 9 connected with the touch-sensor system 4 may be present on a server side like a cloud service, and the touch-sensor system 4 itself may have a function of the host terminal 9 and thereby control display.

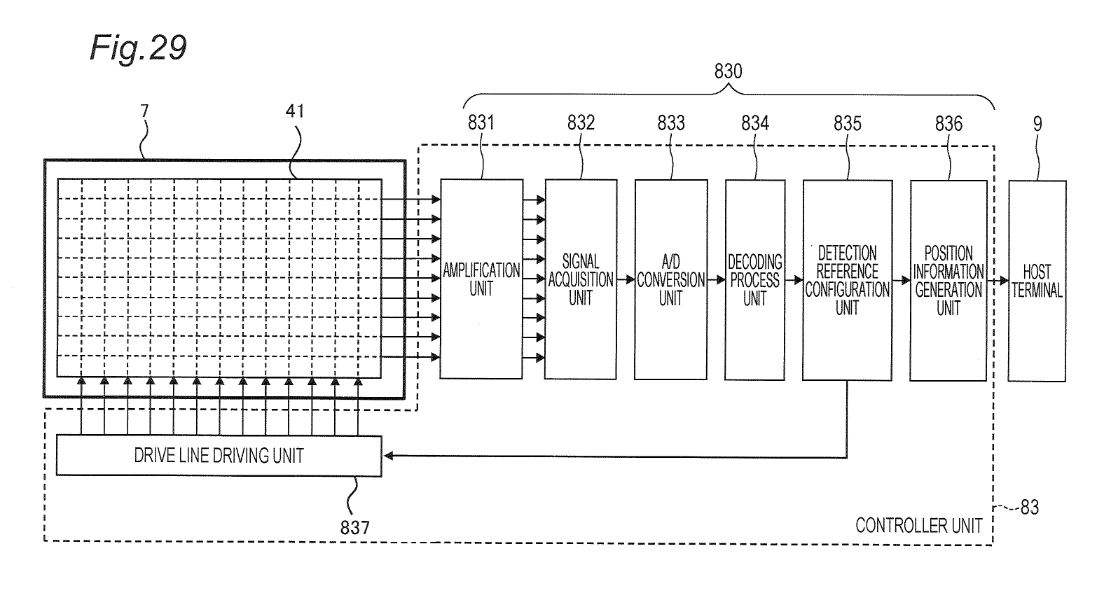

FIG. 29 is a block diagram that illustrates a configuration example in a controller 83 of the touch-sensor system 4 in FIG. 28.

In FIG. 29, the controller unit 83 of the first embodiment has an indicating body position detection unit 830 that processes the plural signals from the plural sense lines to detect the position of the indicating body in the touch panel surface (the position information (x, y) of the indication detection region) and the capacitance information (z) and a drive line driving unit 837 that sequentially drives.

The indicating body position detection unit 830 has an amplification unit 831 that respectively amplifies plural output signals output from the plural sense lines SL, a signal acquisition unit 832 that acquires the output signals which are respectively amplified by the amplification unit 831 and outputs those in a time-division manner, an A/D conversion unit 833 that converts analog signals output from the signal acquisition unit 832 into digital signals, a decoding process unit 834 that obtains the distribution of change amounts in the capacitance in a detection plane P based on the digital signals resulting from A/D conversion by the A/D conversion unit 833, a detection reference configuration unit 835 that configures detection reference values (threshold values) used in a case where a position information generation unit 836, which will be described later, detects the position of the indicating body (the position information (x, y) of the indication detection region) in the touch panel surface, and the position information generation unit 836 that detects the touch position of the indicating body (the position information (x, y)) in the touch panel surface and the touch shape (the position information (x, y) of the detection region of the conductive pattern) based on the detection reference values with respect to the distribution of the change amounts in the capacitance which is obtained by the decoding process unit 834 and thereby generates the position information indicating the position of the indicating body.

The position information generation unit 836 uses the distribution of the change amounts in the capacitance in the touch panel surface which is obtained by the decoding process unit 834 and the detection reference, obtains the touch position (including a region) of the indicating body in the touch panel surface, and thereby generates the position information.

The position information generation unit 836 obtains the touch position or touch region (the shape of the conductive pattern) in the distribution of the change amounts in the capacitance in the touch panel surface and may accept the touch position or touch region (the shape of the conductive pattern) of the indicating body that contacts with or adjoins the touch panel surface as the touch position or touch position region in a case where the change amount in the capacitance in the touch position or touch region is larger than the detection reference value. In a case where the indication detection region on the touch panel surface is larger than a prescribed region or is different from a prescribed shape and where the position information generation unit 836 recognizes that the indication detection region is not the finger or the stylus but at least any of the identifying bodies 1 and 1A to 1C for a touch-sensor system, the shape of the conductive pattern may be used for code verification. As described above, distinction between the finger or the stylus and at least any of the identifying bodies 1 and 1A to 1C may be made not only by the size of the detection region but also by a prescribed shape (shape difference).

Here, in the present application, the plural drive lines and the plural sense lines may be switched between the longitudinal and width directions. Upper electrodes in FIG. 21 may be provided as the drive lines, and lower electrodes may be provided as the sense lines. The upper electrodes may be provided as the sense lines, and the lower electrodes may be provided as the drive lines.

In the foregoing, the present invention has been exemplified by using the preferable first to fourth embodiments of the present invention. However, it should be noted that the present invention is not construed as limited to the first to fourth embodiments. It is understood that the scope of the present invention should be construed only by claims. It is understood that persons skilled in the art may practice the equivalent scope to the specific and preferable first to fourth embodiments of the present invention based on the descriptions of the present invention and technical common knowledge. It is understood that patents, patent applications, and literatures quoted in this specification, and contents of which should be cited as reference for this specification in the same manner as the contents themselves are specifically described in this specification.

### INDUSTRIAL APPLICABILITY

In a field of a touch-sensor system of an identifying body for a touch-sensor system for performing user authentication by using identification and the touch-sensor system in which the identifying body is used to perform identification and input operations by touch or multi-touch, the present invention may more accurately detect a shape of the identifying body as seen from a touch panel surface not by correcting a ghost on a controller side of the touch-sensor system or distinguishing the ghost from a real touch by a sensor unit but by rectifying the ghost on the identifying body side and increasing a detection signal.

1. An identifying body for a touch-sensor system, the identifying body comprising:
a conductive pattern unit in which a conductive pattern is formed in a shape to be recognized by the touch-sensor system by being brought into contact with or into close vicinity to a touch panel surface of the touch-sensor system; and
a virtual grounding circuit unit that is connected with the conductive pattern unit and has an energy loss unit which consumes energy with respect to a frequency of a drive signal which is used by the touch-sensor system.

2. The identifying body for a touch-sensor system according to claim 1, wherein the energy loss unit includes a series resonance circuit.

3. The identifying body for a touch-sensor system according to claim 1, wherein an antenna circuit is used as the virtual grounding circuit unit.

4. The identifying body for a touch-sensor system according to claim 2, wherein the energy loss unit is configured to resonate at a frequency lower than a drive frequency.

5. The identifying body for a touch-sensor system according to claim 1, wherein as the virtual grounding circuit unit, a coil circuit or a coil circuit that includes an eddy-current loss unit is used.

6. The identifying body for a touch-sensor system according to claim 1, wherein the conductive pattern is a portion of or the whole of the virtual grounding circuit unit.

7. The identifying body for a touch-sensor system according to claim 1, wherein
the conductive pattern is a portion of or the whole of the virtual grounding circuit unit, and
the conductive pattern is formed of a coil.

8. A touch-sensor system that enables reading and identification of a shape of a conductive pattern of an identifying body for a touch-sensor system by installing the identifying body for the touch-sensor system according to claim 1 on a touch panel surface that enables a position input operation.
